(19) United States
(12) Patent Application Publication
(10) Pub. No.: US 2026/0140282 A1
(43) Pub. Date: May 21, 2026

(54) COHERENT MID-INFRARED LIGHT EMITTERS

(71) Applicant: Northeastern University, Boston, MA (US)

(72) Inventors: Srinivas Tadigadapa, Sharon, MA (US); Soheil Farazi, Boston, MA (US)

(21) Appl. No.: 19/392,911

(22) Filed: Nov. 18, 2025

Related U.S. Application Data
(60) Provisional application No. 63/722,326, filed on Nov. 19, 2024.
(60) Provisional application No. 63/722,327, filed on Nov. 19, 2024.

(51) Int. Cl. G02B 1/00; G02B 27/30

(52) U.S. Cl. CPC G02B 1/005; G02B 27/30

(57) ABSTRACT

The present disclosure provides a mid-infrared thermal emitter comprising a phononic substrate, a dielectric layer bonded to the phononic substrate with a periodic grating structure formed thereon, and a membrane heater integrated with the phononic substrate. The thermal emitter is configured to produce narrowband coherent emission in the mid-infrared wavelength range between 10 micrometers and 12 micrometers with a quality factor greater than 100. The disclosure also provides a method of fabricating a coherent light-emitting metasurface for mid-infrared applications by creating a composite structure through forming a bonded interface between a dielectric layer and a phononic substrate, thinning the composite structure to a desired thickness, and forming periodic grating patterns in the dielectric layer to create a metasurface supporting off-gamma point Friedrich-Wintgen bound states in the continuum for coherent light emission in a wavelength range between 3 micrometers and 50 micrometers.

### CROSS REFERENCE TO RELATED APPLICATIONS

This application claims the benefit of U.S. Provisional Application No. 63/722,326, filed Nov. 19, 2024, and U.S. Provisional Application No. 63/722,327, filed Nov. 19, 2024, the contents of which are hereby incorporated by reference.

### GOVERNMENT SUPPORT

This invention was made with Government support under ECCS 2016636 awarded by the National Science Foundation. The Government has certain rights to this invention.

### BACKGROUND

Embodiments of the present disclosure relate to coherent mid-infrared light emitters, and more specifically, to coherent mid-infrared light emitters using metasurfaces.

### BRIEF SUMMARY

According to an aspect of the present disclosure, a coherent light-emitting metasurface for mid-infrared wavelengths is provided. The coherent light-emitting metasurface comprises a phononic substrate. The coherent light-emitting metasurface comprises a dielectric layer bonded to the phononic substrate. The coherent light-emitting metasurface comprises periodic grating patterns formed in the dielectric layer having dimensions and spacing to create resonant modes coupling radiative and non-radiative states to form off-gamma point Friedrich-Wintgen bound states in the continuum that, when thermally excited, emit coherent light with high quality factor resonances in a wavelength range between 3 micrometers and 50 micrometers.

According to various embodiments of the present disclosure, the coherent light-emitting metasurface may include one or more of the following features. The phononic substrate may comprise silicon carbide. The dielectric layer may comprise silicon. The silicon may have a single-crystalline morphology. The periodic grating patterns may comprise silicon bars having a width of approximately 2 micrometers and a pitch of approximately 6.6 micrometers. The dielectric layer may be bonded to the phononic substrate using direct fusion bonding. The metasurface may produce emission peaks with quality factors of at least 640 in the mid-infrared wavelength range. The phononic substrate may be thinned to approximately 10 micrometers thickness to reduce thermal mass. The membrane heater may operate at milliwatt power levels to heat the thinned phononic substrate.

According to another aspect of the present disclosure, a method of fabricating a coherent light-emitting metasurface for mid-infrared applications is provided. The method comprises creating a composite structure by forming a bonded interface between a dielectric layer and a phononic substrate. The method comprises thinning the composite structure to a desired thickness. The method comprises forming periodic grating patterns in the dielectric layer to create a metasurface supporting off-gamma point Friedrich-Wintgen bound states in the continuum for coherent light emission in a wavelength range between 3 micrometers and 50 micrometers.

According to various embodiments of the present disclosure, the method may include one or more of the following features. The forming the bonded interface may comprise one of bonding the dielectric layer to the phononic substrate, sputtering the dielectric layer onto the phononic substrate, and using chemical vapor deposition to deposit the dielectric layer onto the phononic substrate. The phononic substrate may comprise silicon carbide and the dielectric layer may comprise silicon. The silicon may be single crystalline silicon. The forming of periodic grating patterns may comprise photolithography followed by reactive ion etching to create silicon bars having a width of approximately 2 micrometers and a pitch of approximately 6.6 micrometers. The thinning may comprise grinding and polishing the phononic substrate to approximately 10 micrometers thickness, and the method may further comprise patterning a titanium heater on the phononic substrate, aligning the patterned heater with bond pads on a handle substrate, and bonding the patterned heater to the bond pads using solder bonding.

According to another aspect of the present disclosure, a mid-infrared thermal emitter is provided. The mid-infrared thermal emitter comprises a phononic substrate. The mid-infrared thermal emitter comprises a dielectric layer bonded to the phononic substrate, the dielectric layer having a periodic grating structure formed thereon. The mid-infrared thermal emitter comprises a membrane heater integrated with the phononic substrate, wherein the thermal emitter is configured to produce narrowband coherent emission in the mid-infrared wavelength range between 10 micrometers and 12 micrometers with a quality factor greater than 100.

According to various embodiments of the present disclosure, the mid-infrared thermal emitter may include one or more of the following features. The phononic substrate may have a negative real part of permittivity at wavelengths between 10.3 micrometers and 12 micrometers. The dielectric layer may have a thickness between 1.0 micrometer and 1.5 micrometers and the periodic grating structures may have a depth of approximately 0.44 micrometers. The phononic substrate may be thinned to approximately 10 micrometers thickness and the membrane heater may operate at milliwatt power levels to efficiently heat the thinned substrate for enhanced mid-infrared emission intensity. The emission may be between 10 micrometers and 12 micrometers and may have a quality factor of at least 100.

### BRIEF DESCRIPTION OF THE DRAWINGS

FIG. 1 illustrates a cross-sectional view of a light-emitting metasurface, according to aspects of the present disclosure.

FIG. 2 depicts a graph showing emissivity as a function of wavelength for various air gap sizes in a tunable mid-infrared light-emitting metasurface structure, according to an embodiment.

FIG. 3 depicts a two-dimensional plot showing emissivity as a function of film thickness and wavelength, according to aspects of the present disclosure.

FIG. 4 illustrates a top-down view of a fabricated metasurface structure showing a periodic grating pattern, according to an embodiment.

FIG. 5 depicts a graph showing emissivity as a function of wavelength for the light-emitting metasurface at a specific emission angle, according to aspects of the present disclosure.

FIG. 6 depicts a graph showing reflectivity as a function of wavelength for the light-emitting metasurface, according to aspects of the present disclosure.

FIG. 7 depicts a two-dimensional emissivity plot as a function of emission angle and wavelength for Transverse Electric (TE)-polarized light, according to aspects of the present disclosure.

FIG. 8 depicts a two-dimensional plot showing emissivity as a function of emission angle and wavelength for TM polarization, according to an embodiment.

FIG. 9 depicts emissivity as a function of emission angle and wavelength for a silicon film for TE-polarized light, according to aspects of the present disclosure.

FIG. 10 depicts a graph showing emissivity as a function of wavelength for a fabricated light-emitting metasurface, according to an embodiment.

FIG. 11 depicts emissivity as a function of emission angle and wavelength for TE polarization in the light-emitting metasurface structure, according to aspects of the present disclosure.

FIG. 12 depicts a two-dimensional plot showing emissivity as a function of film thickness and wavelength for the light-emitting metasurface structure, according to an embodiment.

FIG. 13 depicts a two-dimensional spatial distribution of the real part of the x-component of the magnetic field within the metasurface structure, according to aspects of the present disclosure.

FIG. 14 depicts a two-dimensional spatial distribution of the real part of the magnetic field component within the metasurface structure, according to an embodiment.

FIG. 15 depicts a two-dimensional color map showing the distribution of the electric field magnitude within a cross-section of the metasurface structure, according to aspects of the present disclosure.

FIG. 16 displays a scanning electron microscope image of a fabricated phononic-based metasurface structure, according to an embodiment.

FIG. 17 depicts a graph showing emissivity as a function of wavelength for various air gap sizes in the tunable mid-infrared light-emitting metasurface structure, according to aspects of the present disclosure.

FIG. 18 illustrates a schematic representation of an experimental setup for thermal emission measurements of the light-emitting metasurface, according to an embodiment.

FIG. 19 depicts a graph showing emissivity as a function of wavelength for TE-polarized emission from the metasurface, according to aspects of the present disclosure.

FIG. 20 depicts a graph showing emissivity as a function of wavelength for a quasi-BIC light-emitting metasurface, according to an embodiment.

FIG. 21 illustrates a fabrication process for a coherent light-emitting metasurface, according to aspects of the present disclosure.

FIG. 22 depicts a graph showing emissivity as a function of wavelength for the light-emitting metasurface, according to an embodiment.

FIG. 23 illustrates a schematic representation of a coherent light-emitting metasurface capable of forming symmetry-protected bound states in the continuum, according to aspects of the present disclosure.

FIG. 24 depicts a graph showing emissivity as a function of wavelength for different asymmetry angles in the coherent light-emitting metasurface, according to an embodiment.

FIG. 25 illustrates a schematic cross-sectional view of a coherent light-emitting metasurface capable of forming gamma point Friedrich-Wintgen bound states in the continuum, according to aspects of the present disclosure.

FIG. 26 depicts emissivity as a function of emission angle and wavelength for TE polarization, according to an embodiment.

FIG. 27 depicts emissivity as a function of emission angle and wavelength for TM polarization, according to aspects of the present disclosure.

FIG. 28 illustrates a fabrication process for coherent light-emitting metasurfaces, according to an embodiment.

FIG. 29 illustrates a fabrication process for integrating a membrane heater onto the backside of a light-emitting device, according to aspects of the present disclosure.

FIG. 30 illustrates a fabrication process for integrating a membrane heater using a silicon-on-insulator wafer bonded to a silicon carbide substrate, according to an embodiment.

FIG. 31 illustrates a cross-sectional view of a cavity-enhanced coherent mid-infrared light emitter architecture, according to aspects of the present disclosure.

FIG. 32 illustrates a cross-sectional view of a variable gap BIC mid-IR emitter structure, according to an embodiment.

FIG. 33 depicts a graph illustrating the emissivity spectrum as a function of wavelength for the light-emitting metasurface structure, according to aspects of the present disclosure.

FIG. 34 depicts a graph showing emissivity as a function of wavelength for various air gap sizes in the tunable mid-infrared light-emitting metasurface structure, according to an embodiment.

FIG. 35 illustrates a top view of a tunable quasi-BIC IR emitter, according to aspects of the present disclosure.

FIG. 36 illustrates a cross-sectional view of the tunable quasi-BIC IR emitter, according to an embodiment.

FIG. 37 depicts a flowchart of a fabrication process for a tunable quasi-BIC infrared emitter, according to aspects of the present disclosure.

### DETAILED DESCRIPTION

The mid-infrared (mid-IR) wavelength spectrum represents one of the most abundantly available forms of radiation due to black body emission peaks at room temperature. This wavelength range can be used to study and identify molecular species with their unique vibrational and rotational spectral signatures, and is rapidly emerging as a wavelength band for terahertz and optical communication systems. The development and fabrication of chip-scale coherent MIR sources may have wide-ranging applications including lasing, imaging, IR spectroscopy, and optical communications which may not be readily accomplished using currently available spontaneous and broadband emitters or bulky coherent sources at these wavelengths.

While narrowband emitters have been developed with considerable success in the visible and near-infrared wavelength spectra using wide bandgap semiconductors capable of emitting light at room temperature, manufacturing narrowband light emitters in the mid-IR range, particularly for wavelengths longer than 7 μm, has remained challenging due to technological challenges and material limitations. The only semiconductor lasers operating at wavelengths longer than 7 μm are quantum cascade lasers (QCLs), which have complex structures requiring specialized techniques such as molecular beam epitaxy (MBE) and metal-organic chemical vapor deposition (MOCVD) with precision control of nanometer thickness multilayers. Although phononic materials like silicon carbide (SiC) supporting surface phonon polaritons may provide partially coherent emitters with near-unity emissivity, the large ohmic loss of plasmonic and phononic materials may lead to quality factors of the order of 10, resulting in broadband thermal radiation.

Various embodiments comprise coherent thermal emitters utilizing bound states in the continuum (BICs) to overcome these limitations. BICs are discrete states that lie inside the radiation spectrum but remain localized with no radiation, and when operating in the quasi-BIC regime, may establish narrowband emission peaks with Q-factors as high as 640. Various embodiments comprise a platform for mid-infrared light emission utilizing various types of BICs within the same structure, including off-Γ Friedrich-Wintgen BICs and symmetry-protected BICs, which may enable chip-scale coherent light emitters for applications such as optical communication, sensing, and IR spectroscopy. The phononic metasurface structures described herein may be employed to design and fabricate narrowband coherent light emitters in the mid-infrared wavelengths with large tolerance to fabrication imperfections.

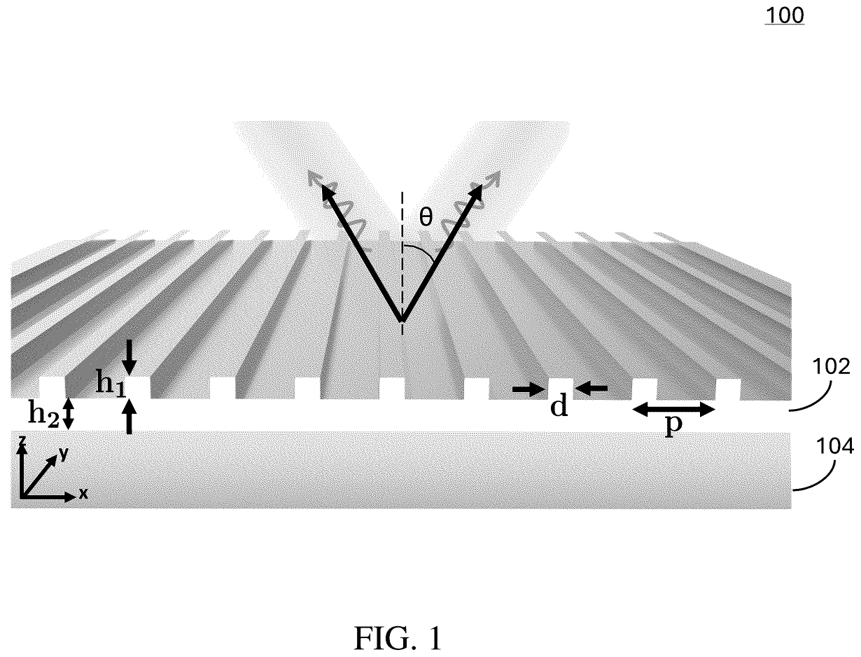

FIG. 1 illustrates a schematic of a light emitting metasurface 100 in accordance with one or more embodiments of the present disclosure. Metasurface 100 comprises a phononic substrate 104 and a dielectric layer 102. Periodic grating patterns may have been formed in dielectric layer 102.

Any dielectric layer as described herein may comprise any optically transparent material in the mid-IR range including silicon (Si), Gallium arsenide (GaAs), Indium arsenide (InAs), Germanium (Ge), Calcium fluoride (CaF₂), Barium fluoride (BaF₂), Zinc selenide (ZnSe), or other suitable materials with appropriate optical properties. Phononic substrate 104 may comprise any thermal or blackbody source, plasmonic or phononic material. Examples include Silicon Carbide, Aluminium Nitride (AlN), Gold (Au), Quartz (SiO₂), Tungsten (W), Carbon-Based Materials, Ceramic Materials (such as Al₂O₃, ZrO₂, HfO), Chalcogenide Glasses, or other materials capable of thermal emission.

Metasurfaces as described herein may be fabricated using various methods. For example, an exemplary dielectric layer 102 may be deposited onto an exemplary phononic substrate. Deposition methods may encompass physical vapor deposition processes such as RF or DC sputter deposition, electron-beam (e-beam) evaporation, molecular beam epitaxy (MBE), pulsed laser deposition, and chemical vapor deposition methods such as atomic layer deposition (ALD), chemical vapor deposition (CVD), low-pressure chemical vapor deposition (LPCVD), high-pressure chemical vapor deposition (HPCVD), metal-organic chemical vapor deposition (MOCVD), spin coating methods, and other physical or chemical vapor deposition techniques suitable for film fabrication. Standard and modified versions of these techniques, as well as combinations thereof, may be employed to achieve desired metasurface characteristics.

For example, the exemplary dielectric layer may be bonded to the exemplary substrate using various bonding techniques. The bonding techniques may comprise direct (fusion) bonding, anodic bonding, adhesive bonding, intermediate layer bonding, hydrophilic and hydrophobic bonding, thermocompression bonding, metal diffusion bonding, Van der Waals bonding, plasma-assisted bonding, glass frit bonding, laser-assisted bonding, or other suitable bonding methods. These bonding methods, either individually or in combination, may be utilized to achieve attachment of the exemplary dielectric layer to the exemplary phononic substrate, providing versatility in terms of material compatibility, bonding strength, and application-specific requirements.

In cases where the exemplary dielectric layer has been bonded to phononic substrate 104, it may be tailored to a desired thickness using various methods, including grinding, polishing, wet etching, dry etching, or other suitable thinning techniques.

The materials used for metasurfaces may exhibit various morphologies, including amorphous, polycrystalline, single-crystalline, monocrystalline structures, or other suitable crystalline arrangements. The morphology may be controlled or influenced based on the deposition or fabrication method used, and may include mixed-phase structures, nanocrystalline formations, textured crystalline arrangements, or other structural configurations. These morphologies may be selected or engineered to achieve specific optical, electrical, or mechanical properties of metasurfaces described herein, providing versatility in performance depending on the application requirements.

Metasurface patterns and features may be created using various methods, including photolithography, electron-beam (e-beam) lithography, 3D printing, direct printing, embossing, nanoimprint lithography, interference lithography, and other suitable patterning techniques. This may also include techniques such as dry etching (e.g., reactive ion etching, plasma etching), wet etching, lift-off processes, direct printing of patterns, direct-write laser lithography, focused ion beam (FIB) milling, additive manufacturing methods, or other suitable patterning approaches. Any of these methods, or combinations thereof, may be employed for creating the desired metasurface features.

Metasurface features or patterns may take on various shapes and distributions, which may be configured in periodic or non-periodic arrangements, including unit cells, supercells, or combinations thereof with or without strict periodicity. The features may be designed to support bound states in the continuum (BICs), including symmetry-protected BICs, Friedrich-Wintgen BICs, Fabry-Perot BICs, accidental BICs, or other types of BICs. These shapes may be symmetric or non-symmetric and may encompass a broad range of geometries to facilitate different types of BICs. The shapes may include gratings, nanobars or microbars, tilted bars, asymmetric pairs of bars, split-ring structures, nanodisks with asymmetric holes, elliptical structures, rectangular and triangular structures, square blocks, circular disks, ring-shaped elements, hexagonal elements, crosses, U-shaped, H-shaped, L-shaped, C-shaped nanoantennas, dumbbell-like structures, Fano-resonant asymmetric wire pairs, square split-ring resonators, or other arbitrary, fractal-like, or hybrid geometries that may exhibit desired resonance properties. Metasurface features may be distributed in lattices of various symmetries, such as square, rectangular, hexagonal, triangular arrangements, quasi-crystalline arrangements, aperiodic arrangements, or other suitable distributions. The structures may be designed to achieve and optimize specific resonance properties, enabling control over coherence, radiation suppression, and field enhancement as required for different BIC phenomena.

As depicted in FIG. 1, dielectric layer 102 has been patterned as a grating of substantially parallel ribs spaced apart by dimension, p, and having a height, h₁, and a depth, d. As shown in FIG. 1, dielectric layer 102 has a total thickness of h₁+h₂, where h₂ is the thickness of the dielectric layer 102 at the trough between grating ribs.

Exemplary metasurface may be configured to function as a selective transmitter or absorber, forming narrowband transmission or absorption windows based on the principles of bound states in the continuum (BICs). These configurations may allow for precise control over the spectral response, enabling applications in filtering, sensing, tailored electromagnetic manipulation, or other suitable applications.

An exemplary light-emitting device may comprise metasurface 100, and an integrated membrane heater. Phononic substrate 104 may be thinned to approximately 10 μm or other suitable thickness to reduce thermal mass, enabling efficient heating with a micro heater operating at milliwatt (mW) power levels or other appropriate power levels. The integration of the membrane heater may be configured through processes that include deposition techniques such as sputtering or chemical vapor deposition (CVD) with subsequent bonding, wafer bonding processes, or other suitable integration methods. The light-emitting device may be designed to emit sufficient radiated power for various applications with minimal power input, ensuring efficient thermal management through the reduced thermal mass of phononic substrate 104.

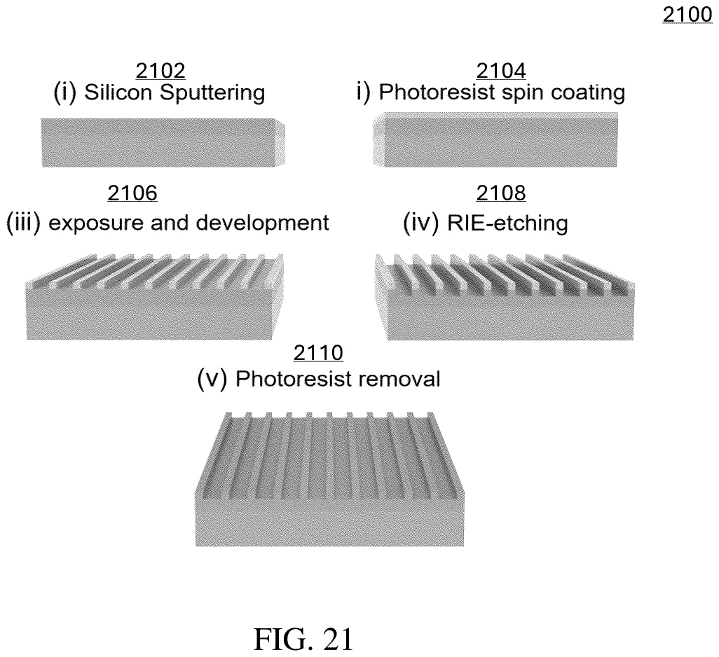

Various metasurfaces described herein may be fabricated according to various fabrication techniques. For example, metasurface 100 (and/or other metasurfaces according to one or more embodiments of the present disclosure) may be fabricated according to a fabrication process 2100 depicted in FIG. 21.

FIG. 21 illustrates one embodiment of a fabrication process 2100 for creating a coherent light-emitting metasurface. Step 2102 may comprise silicon sputtering onto a substrate material. In this step, a silicon layer may be deposited using sputter deposition techniques to form the dielectric layer that will support the metasurface structures. The silicon deposition may be performed under controlled conditions to achieve desired film thickness and material properties.

Step 2104 may comprise photoresist spin coating. During this step, a photoresist material may be applied to the silicon surface through spin coating techniques. The photoresist layer may be uniformly distributed across the wafer surface at controlled spin speeds to achieve consistent film thickness. The photoresist may serve as a masking layer for subsequent patterning operations.

Step 2106 may comprise exposure and development. In this step, the photoresist may be exposed to light through a photolithographic mask that defines the desired metasurface pattern. The exposure process may utilize appropriate wavelength light sources to transfer the mask pattern into the photoresist. After exposure, the photoresist may be developed to remove either the exposed or unexposed regions, depending on the resist type, revealing the underlying pattern that will define the periodic grating structures.

Step 2108 may comprise reactive ion etching (RIE). During this etching step, the exposed silicon regions may be selectively removed through dry etching techniques. The RIE process may transfer the photoresist pattern into the underlying silicon material, creating the raised structures and recessed grooves that form the metasurface grating patterns. The etching parameters may be controlled to achieve desired etch depth and sidewall profiles.

Step 2110 may comprise photoresist removal. In this step, the remaining photoresist material may be stripped away using chemical solvents, plasma ashing, or other suitable removal techniques. This step may reveal the completed metasurface structure with its periodic grating patterns formed in the silicon dielectric layer, ready for integration into a light-emitting device.

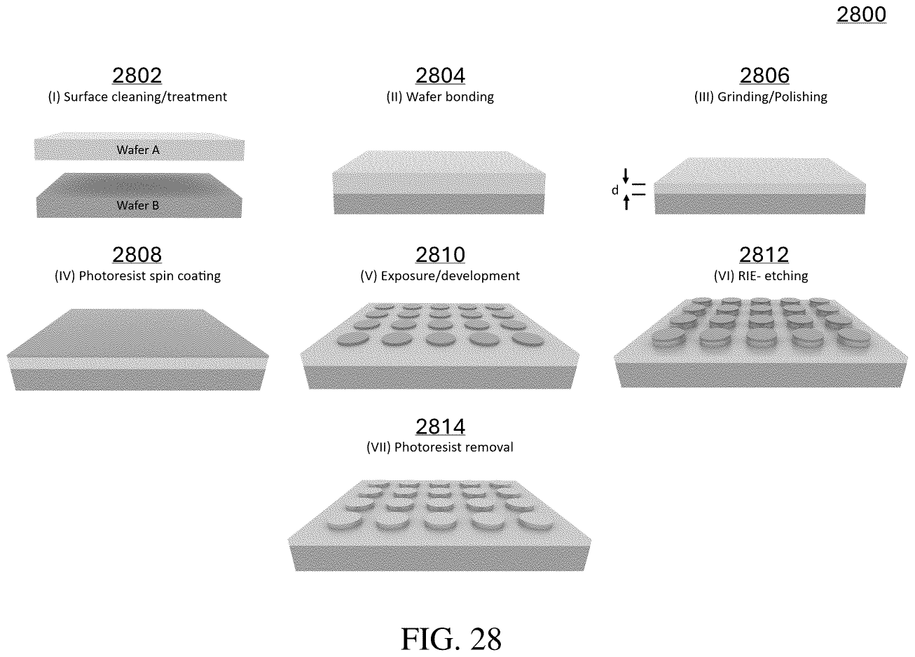

Metasurface 100 (and/or other metasurfaces according to one or more embodiments of the present disclosure) may be fabricated according to an alternative fabrication process 2800, as depicted in FIG. 28. Operation 2802 may comprise preparing two separate wafers for the fabrication process. Wafer A may be a dielectric layer. Wafer B may be a phononic substrate. This operation may comprise surface cleaning and treatment of both wafers to ensure proper bonding conditions and remove any contaminants or native oxides that may interfere with subsequent processing steps.

Operation 2804 may comprise bonding Wafer A to Wafer B to form a composite bilayer structure. The bonding process may utilize direct fusion bonding, anodic bonding, adhesive bonding, or other suitable wafer bonding techniques to create a stable interface between the dielectric layer and phononic substrate. The bonding may be performed under controlled temperature and pressure conditions to achieve uniform adhesion across the wafer surface. Operation 2806 may comprise thinning the composite structure through grinding and polishing operations. Wafer A may be mechanically reduced to a desired thickness through precision grinding followed by chemical-mechanical polishing (CMP) or other suitable thinning techniques. This operation may reduce the thermal mass of the structure and achieve the target thickness for optimal optical performance.

Operation 2808 may comprise applying a photoresist layer to the thinned surface through spin coating. The photoresist material may be uniformly distributed across the wafer surface at controlled spin speeds and acceleration rates to achieve a consistent film thickness. The photoresist may serve as a masking layer for subsequent patterning operations. Operation 2810 may comprise exposing and developing the photoresist to create a periodic pattern. The exposure process may utilize photolithography techniques with appropriate wavelength light sources and mask patterns to define the desired metasurface geometry. The development process may remove exposed or unexposed photoresist regions, depending on the resist type, to reveal the underlying pattern of periodic features arranged in a regular array.

Operation 2812 may comprise transferring the photoresist pattern into the underlying dielectric material through reactive ion etching (RIE) or other suitable dry etching techniques. The etching process may selectively remove material from unprotected regions while preserving areas covered by the photoresist mask, creating raised structures or recessed features that form the metasurface grating patterns. Operation 2814 may comprise removing the remaining photoresist material through chemical stripping, plasma ashing, or other suitable photoresist removal techniques. The metasurface structure formed by process 2800 may be ready for integration into a light-emitting device.

The phononic substrate of an exemplary metasurface 100 comprises a phononic material having a negative real part for permittivity at wavelengths between 10.3 μm and 12 μm. For example, exemplary phononic substrate 104 comprises SiC and dielectric layer 102 comprises Silicon. For example, as shown in FIG. 1, p is the period of the grating, d is the width of silicon bars, h₁and h₂ are the thickness of the silicon grating and the base of the dielectric layer, respectively. In an exemplary geometry, the parameters may be set to p=6.6 μm, d=2 μm, h₁=440 nm, and h₂=1150 nm. Various tests were performed based on such an exemplary metasurface 100.

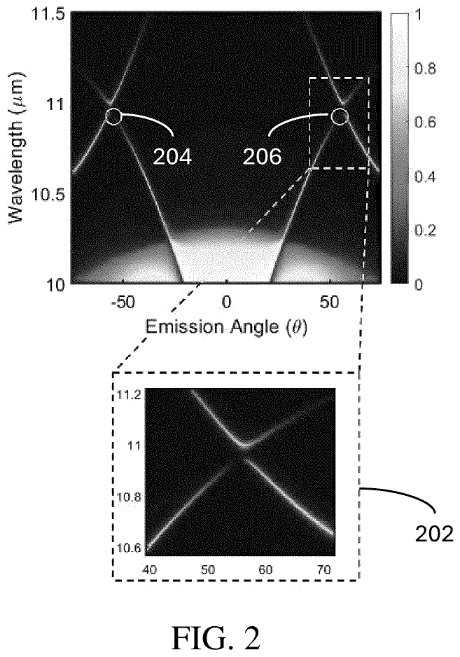

FIG. 2 shows the simulated emissivity for the exemplary geometry for Tranverse Electric (TE) polarization (electric field is along the axis of nano bars) as a function of emission angle and wavelength using Kirchhoff's law as 1−R where R is the sum of the reflection coefficients of all propagating diffraction orders of the structure calculated using rigorous coupled-wave analysis (RCWA). The emissivity was simulated for the exemplary metasurface. FIG. 2 demonstrates an expanded view 202, the regime called “near-BIC” at which a narrowband emission peak is achievable. Circles 204 and 206 indicate the Friedrich-Wintgen BIC points where the avoided crossing occurs and the linewidth of resonance disappears. Even though there may be no emission at the Friedrich-Wintgen BIC point, in the near-BIC regime an emission peak with a high Q-factor may be attainable.

As the depth of the grooves may influence the amplitude of emission peaks in the near-BiC regime, the thickness of the dielectric film may control the wavelength and linewidth of resonances. As a result, the Q-factor of resonances may be engineered by modifying the thickness of the dielectric layer. In addition, strong field enhancement may be a distinctive characteristic of the near-BIC regime. In some cases, a significantly enhanced electric field localized inside the dielectric layer may be observed for the emission peaks demonstrating a dramatic light-matter interaction.

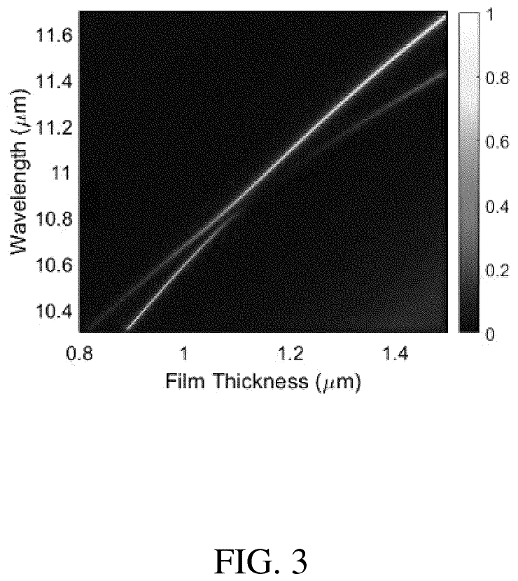

FIG. 3 illustrates the role of the silicon film thickness in emissivity and wavelength for the fixed emission angle θ=55° at the BIC point where the avoided crossing and resonances' interactions are depicted reflection coefficients of all propagating diffraction orders of the structure. The dashed box in FIG. 2 shows the near BIC regime, and circles 204 and 206 indicate the Friedrich-Wintgen BICs where avoided crossing occurs. FIG. 3 illustrates the emissivity spectrum of the geometry as a function of silicon film thickness and wavelength for an exemplary emission angle θ=55° at the BIC point, demonstrating how the resonance behavior may be tuned through geometric parameter variation.

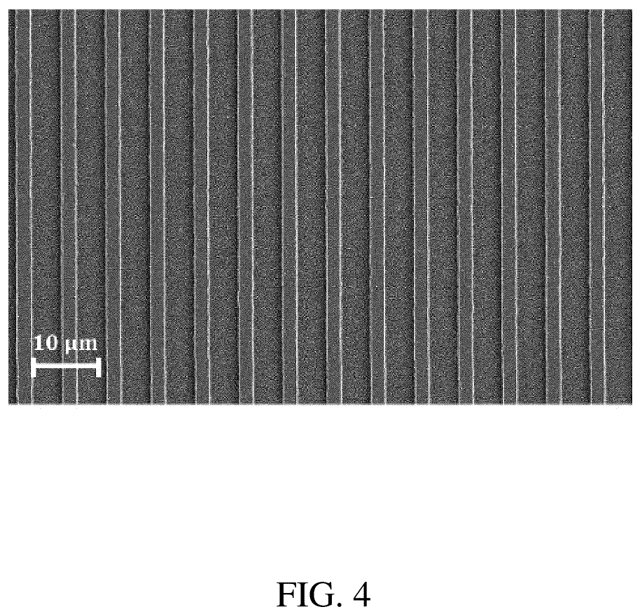

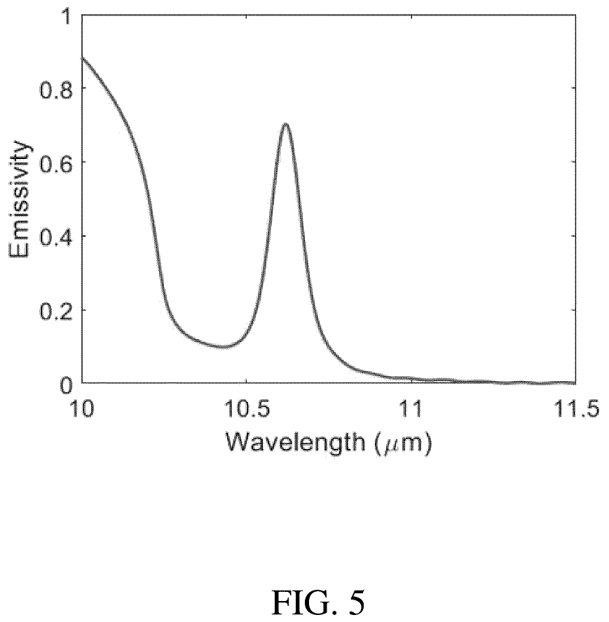

FIG. 4 is an scanning electron microscope (SEM) image of an exemplary fabricated metasurface. In this example, a Silicon layer of 1500 nm thickness was sputter deposited on a 4H—SiCsubstrate. After the silicon sputtering, the grating structure was patterned using a photolithography process followed by dry etching in an ICP-RIE tool to realize silicon bars of width 2 μm with a pitch of 6.6 μm. After fabrication of the metasurface, the emissivity of the sample was measured using Bruker Invenio-R FTIR spectrometer by reflectivity measurement. FIG. 5 shows the measured emissivity of the exemplary device as a function of wavelength at an emission angle θ=40°. The emissivity was measured using an FTIR spectrometer with reflectivity measurement. The quality factor and the magnitude of the measured emissivity was less than the simulated results likely due to impurities and optical losses of the sputtered silicon film.

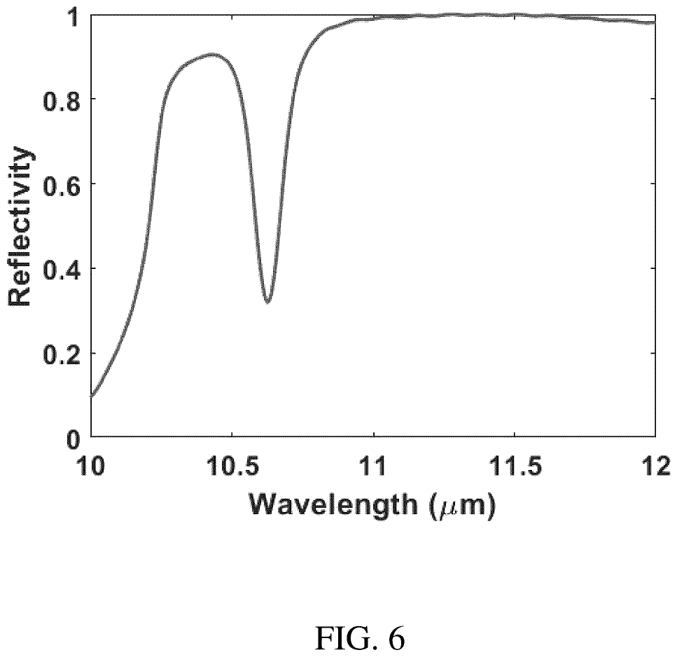

In some embodiments, after the sputter deposition of 1.5 μm silicon film on a 4H—SiC substrate, the grating structure may be patterned by a photolithography process followed by dry etching in an ICP-RIE tool to realize silicon bars of width 2 μm and depth of 0.44 μm with a pitch of 6.6 μm. FIG. 6 illustrates measured reflectivity of the exemplary phononic metasurface depicted in FIG. 5 at angle θ=40° using a Bruker FTIR spectrometer model Invenio-R. Kirchhoff's law indicates that the reflectivity dip in FIG. 6 may correspond to the peak of emission at θ=40°, demonstrating coherent thermal emission from the exemplary phononic metasurface.

As a result of impurities within the sputtered silicon film, the Q-factor of the measured reflectivity dip may be less than the simulated results. Single crystalline silicon may have negligible optical loss at wavelengths desired in this exemplary embodiment. However, depending on the structure of the silicon, defects, and unintended doping, the imaginary part of the sputtered silicon determining the optical loss of the film may be significant.

For crystalline silicon, the imaginary part of the permittivity determining the optical loss of the system may be negligible in the 10-12 μm range. However, for sputtered amorphous silicon films, the optical loss may be considerable depending upon the silicon structure, defects, and doping. These exemplary experimental results on a new class of ultra-narrowband coherent MIR emitters obtained using sputtered films may be promising, and higher Q-factor emissivity may be achieved as the quality of the silicon film is improved through the use of bonded single-crystal silicon films to SiC substrates. The demonstrated source may be utilized to design the next generation of MIR emitters which may pave the way for the development of MIR Vertical Cavity Surface Emitting Lasers (VCSELs).

In various embodiments, BICs may be employed to engineer thermal radiation and enhance the strength of light-matter interaction. Friedrich-Wintgen BICs with substantially zero linewidth may be formed by interfering between two resonances, which may result in the avoidance of resonance crossings. While at the Friedrich-Wintgen BIC point thermal emission may be substantially suppressed, narrowband and near-unitary emission peaks may be present in the near-BIC regime. According to experimental results, the fabricated phononic metasurface may emit coherent light. In some embodiments, by improving the quality of the deposited dielectric layer, which may result in emission peaks with higher amplitude and Q-factor, the disclosed phononic metasurface may be configured to implement narrowband coherent chip-scale light emitters with improved performance characteristics.

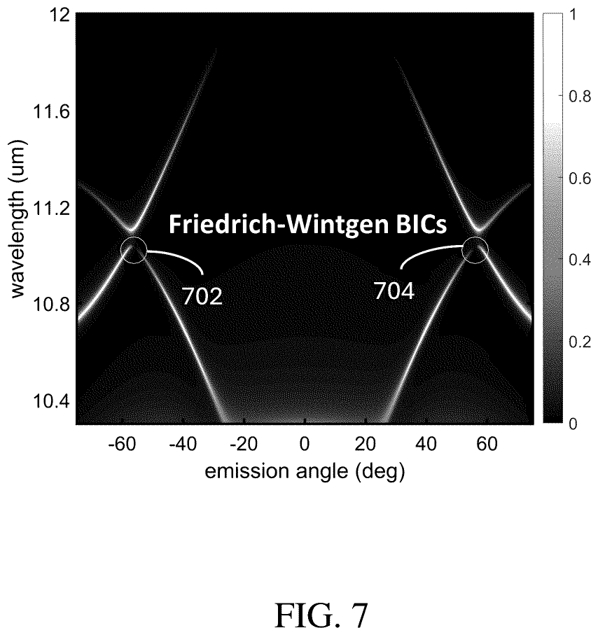

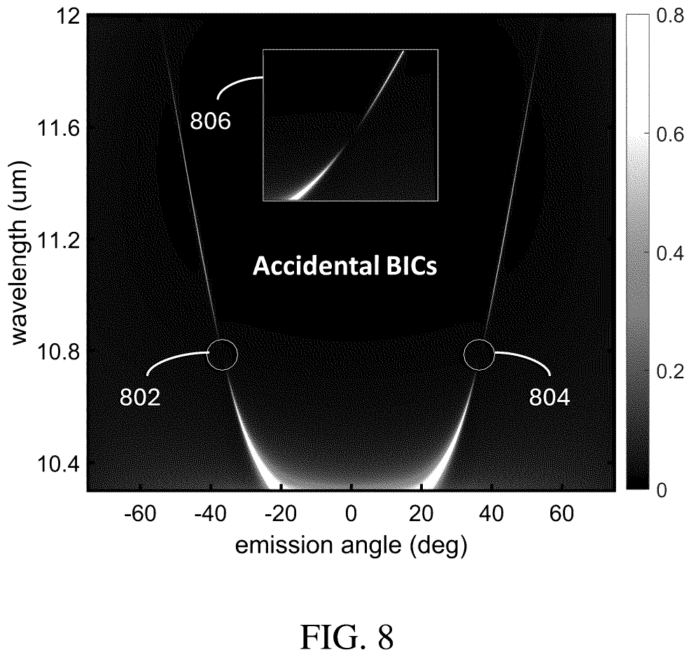

In an exemplary embodiment, emitter 100 may comprise silicon nanobars with a width d=2 μm and a pitch p=6.6 μm. The grooves may have depth h₁=0.5 μm and the silicon film may have thickness h₂=1.2 μm. FIG. 7 illustrates a plot of the emissivity for TE polarized light where the electric field is along the y-axis. By calculating reflectivity using the rigorous coupledwave analysis (RCWA) method, the emissivity may be obtained by Kirchhoff's law as 1−R where R is reflectivity. For TE polarization, the 2D emissivity spectrum may reveal the formation of off-ΓFriedrich-Wintgen BICs in which anti-crossing resonances and a band flip may be observed, as illustrated in FIG. 7 showing emissivity as a function of emission angle and wavelength for TE polarization. As a result of resonance interference, at the BIC point, one of the resonances may turn into a true BIC with no radiation while the other one may become more lossy. Although Friedrich-Wintgen BICs may be formed due to the destructive interference of coupled resonances, a single resonance can also turn into a BIC accidentally through parameter tuning. FIG. 8 demonstrates the emissivity spectrum for TM polarization where an accidental BIC may be observed, illustrating emissivity as a function of emission angle and wavelength for TM polarization and the formation of accidental BICs. In FIGS. 7 and 8, circles 702, 704, 802, and 804 indicate the BIC points. Inset 806 in FIG. 8 provides an expanded view of the near-BIC regime.

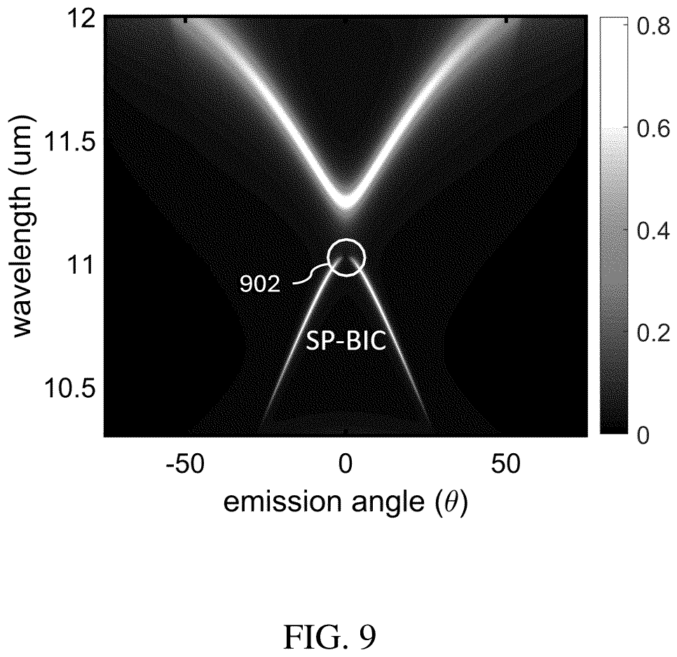

Aside from the off-Γ BICs presented here, the platform may also be capable of forming Γ-point BICs. In an exemplary embodiment, FIG. 9 illustrates the 2D emissivity spectrum for a silicon film with a thickness of 0.6 μm, showing the formation of a Γ-point BIC. FIG. 9 shows emissivity as a function of emission angle and wavelength for the silicon film with a thickness of 0.6 μm for TE-polarized light that may exhibit a symmetry-protected BIC formed at the Γ point of the Brillouin zone in an exemplary embodiment. In some aspects, these types of BICs may be called “symmetry-protected” BICs trapped at the center of the Brillouin zone (Γ point). Upon breaking the lattice symmetry, they may start to radiate and become quasi-BICs with finite resonance linewidths. The near-BIC regime may exhibit high Q-factor emission peaks that can be used to realize chip-scale coherent light emitters in the MIR range. Circle 902 indicates the BIC point.

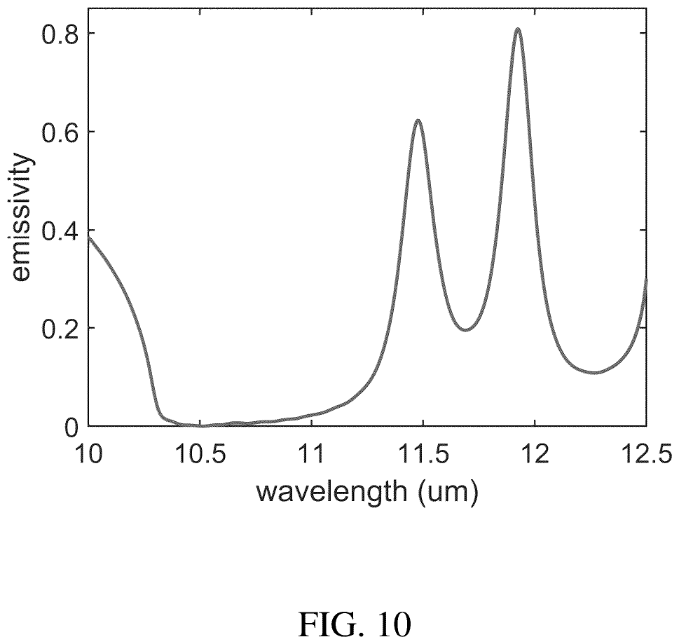

To realize chip-scale coherent light emitters based on symmetry-protected quasi-BICs in an exemplary embodiment, a silicon layer may be sputter-deposited onto a 4H—SiCsubstrate to fabricate the light-emitting metasurface. Nanobars may be created through photolithography followed by plasma etching in an ICP-RIE tool. In some aspects, the emissivity spectrum of the fabricated light-emitting metasurface may be collected by measuring the reflectivity spectrum using a Fourier transform infrared (FTIR) spectrometer. In this exemplary embodiment, FIG. 10 illustrates the emissivity spectrum of the light-emitting metasurface that may be measured at the incidence angle θ=10°, demonstrating the symmetry-broken emission of the quasi-BIC regime. FIG. 10 shows the emissivity spectrum of the fabricated metasurface as a function of wavelength for θ=10° that may be collected by an FTIR-spectrometer through a reflectivity measurement. This figure illustrates the quasi-BIC emission from the fabricated device that may result from the broken symmetry of the structure in this exemplary embodiment. As compared to simulation results, the measured emission spectrum may reveal a red shift for emission peaks originating from the optical properties of the sputter-deposited silicon film. The emission peaks may have a Q-factor of approximately 82, which can be increased by improving the quality of the silicon film using better deposition techniques, accompanied by lower optical losses. In some cases, various techniques may be employed to increase the Q-factor of the quasi-BIC emissions.

Various embodiments demonstrate the formation of diverse bound states in the continuum (BICs) within a unified platform for mid-infrared light emission. In some embodiments, dielectric metasurfaces and phononic substrates may be utilized to achieve high-quality factor emission peaks in the quasi-BIC regime. The platform may support off-Γ Friedrich-Wintgen and accidental BICs and may also enable the realization of symmetry-protected Γ point BICs. The capability to engineer and control BICs, particularly in the quasi-BIC regime, may facilitate the development of chip-scale coherent light emitters with applications that may include optical communication, sensing, and infrared spectroscopy. In some aspects, optimization of fabrication techniques and material quality may enhance the performance, enabling advanced and efficient mid-infrared light sources for practical applications.

In an exemplary embodiment, an off-Γ Friedrich-Wintgen BIC at mid-IR wavelengths between 10 μm and 12 μm achieved temporally coherent light emitters. This was accomplished by stimulating Friedrich-Wintgen coupled resonances within a dielectric metasurface fabricated on a phononic substrate. Experimental results for this exemplary embodiment provide evidence of Friedrich-Wintgen resonances at mid-IR wavelengths. Additionally, temporally coherent emission peaks in the near-BIC regime were observed. As compared to the broadband radiation generated in platforms supporting Γ point and symmetry-protected BICs, various embodiments enable temporally coherent emission in the mid-IR range.

When two Friedrich-Wintgen resonances pass each other as a function of a continuous parameter, such as wavelength or incidence angle, an avoided crossing occurs due to resonance interference. At a certain continuous parameter, one of the resonances vanishes entirely and hence becomes a BIC, resulting in the detection of a single resonance at the BIC point. This type of BIC was first established by Friedrich and Wintgen. By applying temporal coupled-mode theory, Friedrich-Wintgen BICs can be better understood. For two resonance states interfering in the same resonator with resonance frequencies ω_{1,2}, the system can be represented by the effective Hamiltonian

$${H}^{`} = ( \begin{matrix}{ω}_{1} - i {γ}_{1} & κ - i \sqrt{{γ}_{1} {γ}_{2}} \\ κ - i \sqrt{{γ}_{1} {γ}_{2}} & {ω}_{2} - i {γ}_{2}\end{matrix} )$$

where γ_{1,2} are the linewidths of the resonances and κ is the near-field coupling constant. A Friedrich-Wintgen BIC is formed and decoupled from the continuum when one of the eigenvalues becomes purely real. Accordingly, it can be shown that for the condition

$$κ ( {γ}_{1} - {γ}_{2} ) = \sqrt{{γ}_{1} {γ}_{2}} ( {ω}_{1} - {ω}_{2} )$$

one of the eigenvalues has an imaginary part of zero, Im(σ₊)=0, and turns into a BIC with a zero linewidth, while for the other one Im(σ₋)=−(γ₁+γ₂).

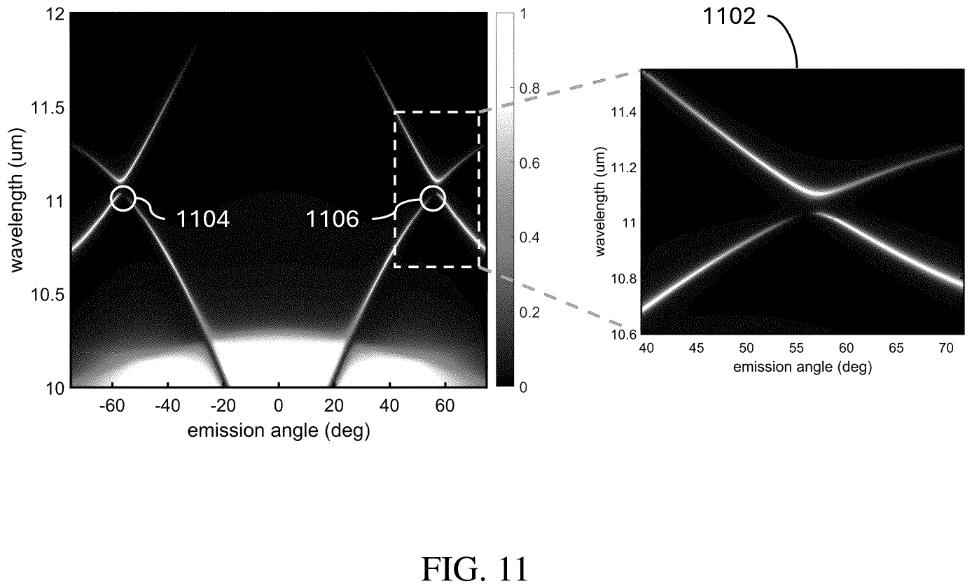

Various implementations utilize Friedrich-Wintgen BICs to realize coherent light emitters. The geometry of an exemplary light-emitting metasurface is illustrated in FIG. 11 where p=6.6 μm, d=2 μm, h₁=0.5 μm, and h₂=1.2 μm. The substrate is silicon carbide (SIC) which is a phononic material with a negative real part for permittivity in the Reststrahlen band between wavelengths of 10.3 μm and 12.5 μm. In this range, the complex permittivity of SiC can be defined by an oscillator model ϵ(ω) with ϵ=6.7, ω_{L}=969 cm⁻¹, ω_{L}=793 cm⁻¹, and τ=4.76 cm⁻¹. The dielectric layer on top of the substrate is silicon with optical properties. FIG. 11 shows the emissivity as a function of emission angle and wavelength for the TE polarization (electric field is along the length of the nano bars) obtained by Kirchhoff's law as 1−R where R is the sum of reflection coefficients of all propagating diffraction orders of the system calculated by rigorous coupled-wave analysis (RCWA). Circles 1104 and 1106 in FIG. 11 indicate the Friedrich-Wintgen BIC points where the linewidth of the resonances becomes zero. FIG. 11 displays an expanded view 1102. This box shows the near-BIC regime at which Friedrich-Wintgen BIC is evident. As the emission angle increases, the resonances approach one another until at one point, the linewidth of one of the resonances drops to zero due to destructive interference of the resonances, resulting in an avoided crossing for the two resonances and a band flip. As a result of the near-field coupling through the silicon layer (κ≠0), BICs will not occur precisely at the crossing point. While the linewidth of the resonance becomes zero at the BIC point, emission peaks with high amplitude and Q-factor can be achieved in the near-BIC regime.

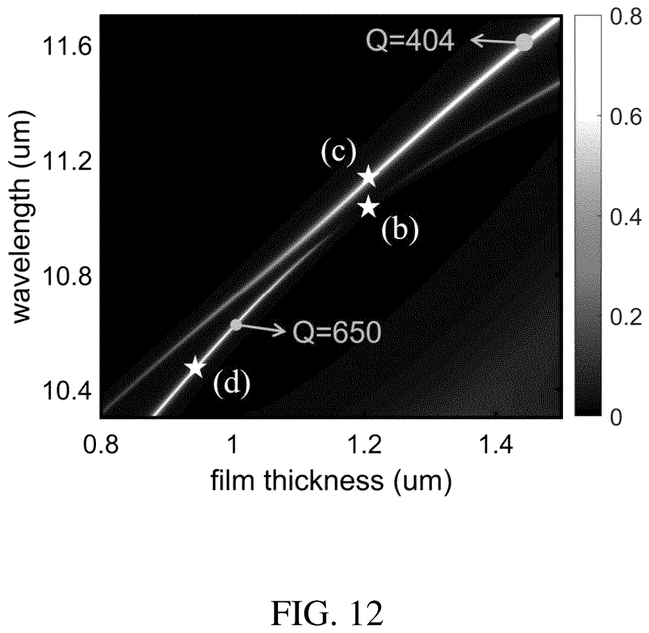

The effect of the dielectric layer (e.g., the silicon film), as a function of its thickness, h₂, and wavelength has been numerically investigated. FIG. 12 illustrates the interaction between the resonances and the avoided crossing at an emission angle θ=56°, corresponding to the angle at which the Friedrich-Wintgen BIC is formed in FIG. 11. The effect of film thickness on the linewidth and location of both resonances is evident. As a result, the Q-factor of the emission peak can be engineered from 404 to 650 by modifying the thickness of the dielectric layer. In this numerical simulation of emissivity and field distribution, the emissivity is shown as a function of dielectric thickness, h₂, and wavelength at emission angle θ=56°. The green dots indicate the locations of emission peaks for which Q-factors have been calculated. Stars indicate the locations of the field profiles illustrated in subsequent figures.

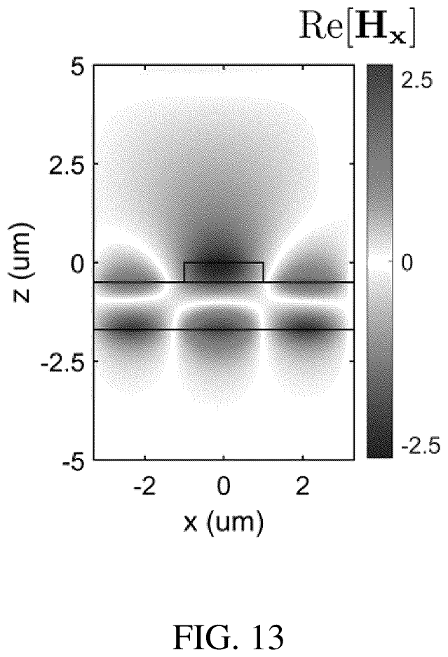

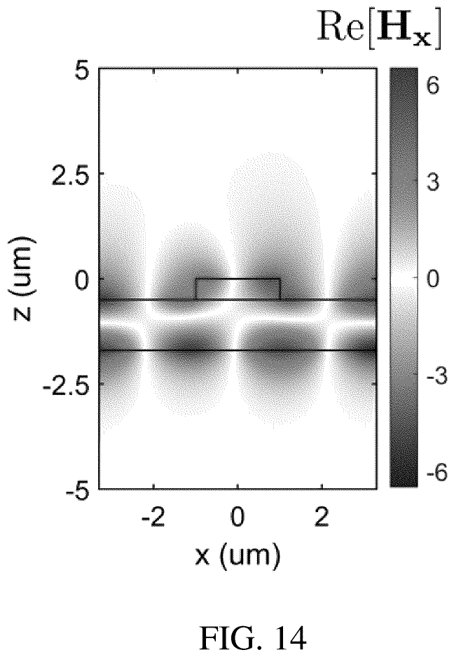

The nearfield distributions within the structure have also been studied. For an exemplary fixed dielectric thickness of h₂=1.2 μm, FIG. 13 and FIG. 14 depict the magnetic field profiles of the BIC point and the emission peak located at wavelengths/=11 μm, and λ=11.12 μm, respectively, which are marked in FIG. 12 with stars. The magnetic field distribution within the structure for dielectric thickness h₂=1.2 μm at wavelength/=11 μm represents the BIC point.

FIG. 13 depicts a two-dimensional spatial distribution of the real part of the x-component of the magnetic field within a metasurface structure at the BIC point. The plot shows the field distribution as a function of position in the x-z plane, with the x-axis ranging from approximately −3 micrometers to 3 micrometers and the z-axis ranging from approximately −5 micrometers to 5 micrometers. The field intensity values range from approximately −2.5 to 2.5, with positive values indicating one phase of the magnetic field oscillation and negative values indicating the opposite phase. The field distribution exhibits a periodic pattern along the x-direction and shows distinct regions of field concentration and variation in the z-direction. A rectangular outline near the center of the plot at z equals approximately 0 micrometers indicates the location of the metasurface structure. The magnetic field pattern demonstrates characteristic features of the BIC mode, with alternating regions of positive and negative field values creating a standing wave pattern within the dielectric layer and surrounding regions of the structure. The field distribution shows relatively uniform intensity throughout most of the computational domain, with some localization occurring near the metasurface boundaries.

FIG. 14 clearly displays a significant enhancement of the magnetic field and light-matter interaction at the interfaces which are well-known characteristics of the near-BIC regime. FIG. 14 depicts a two-dimensional spatial distribution of the real part of the x-component of the magnetic field within a metasurface structure at the near-BIC emission peak. The plot shows the field distribution as a function of position in the x-z plane, with the x-axis ranging from approximately −3 micrometers to 3 micrometers and the z-axis ranging from approximately −5 micrometers to 5 micrometers. The field intensity values range from approximately −6 to 6, representing a significantly enhanced field magnitude compared to the BIC point shown in FIG. 13. The field distribution exhibits strong localization and enhancement at the interfaces of the metasurface structure, with the highest field intensities concentrated near the boundaries of the rectangular metasurface element located at z equals approximately 0 micrometers. The magnetic field pattern shows pronounced variations in intensity, with regions of maximum positive field values reaching approximately 6 and regions of maximum negative field values reaching approximately −6. The field enhancement is particularly evident at the top and bottom interfaces of the metasurface structure, where the field magnitude may be several times larger than in the surrounding regions. This enhanced field localization and the dramatic increase in field intensity compared to the BIC point demonstrate the characteristic light-matter interaction enhancement that occurs in the near-BIC regime, where the quasi-BIC resonance enables strong field confinement within the dielectric layer while maintaining finite radiation for practical light emission applications.

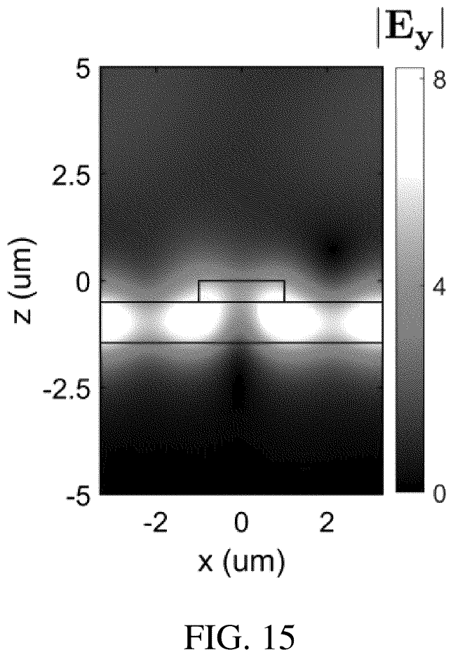

The magnetic field distribution within the structure for dielectric thickness h₂=1.2 μm at wavelength/=11.12 μm corresponds to the near-BIC point. FIG. 15 illustrates the distribution of the electric field for the emission peak at λ=10.5 μm where h₂=0.95 μm, demonstrating a strong field localization inside the dielectric layer at the emission peak. This electric field profile at emission peak located at λ=10.5 μm where h₂=0.95 μm demonstrates field confinement within the dielectric layer.

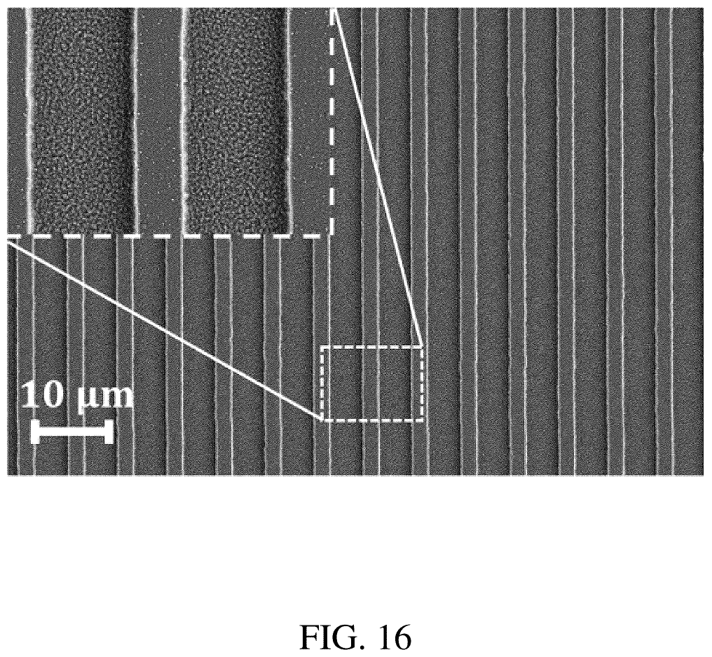

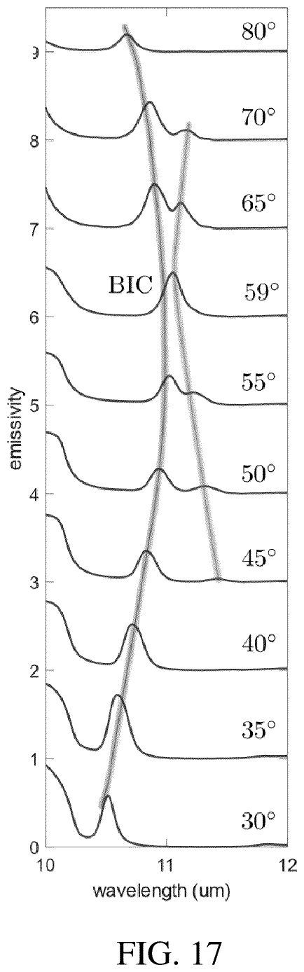

For example, to fabricate the metasurface, a silicon layer with 1.7 μm thickness was sputter deposited on a 4H—SiC substrate. Then, the silicon grating was patterned using a photolithography process followed by dry etching in an ICP-RIE tool. This process resulted in silicon bars of width 2 μm, with a pitch of 6.6 μm. FIG. 16 displays an SEM image of an exemplary metasurface. The SEM image of the fabricated phononic-based metasurface shows the structure where p=6.6 μm, d=2 μm, h₁=0.5 μm, and h₂=1.2 μm. The inset shows an expanded view of the grooves and nano bars. After fabrication of the device, the emissivity of the light emitter was determined using a Bruker FTIR spectrometer model Invenio-R by acquiring reflectivity spectra in response to a TE-polarized incident light. The measured emissivity at different emission angles is depicted in FIG. 17. The measured emissivity from the fabricated light-emitting metasurface as a function of wavelength at various angles demonstrates the Friedrich-Wintgen BIC formation. The left and right lines indicate the trajectory of interference between Friedrich-Wintgen resonances. It is evident that at emission angles below 45°, there is a single emission peak. However, at higher angles, a second emission peak emerges at longer wavelengths. Upon increasing the angle, the two emission peaks corresponding to Friedrich-Wintgen resonances move toward each other until the Friedrich-Wintgen BIC is formed, resulting in the detection of only one emission peak. Moreover, the measured emissivity spectra indicate a temporally coherent emission in the near-BIC regime. The temporal coherence length of the light source can be obtained by

$${L}_{c} = c {τ}_{c} = \sqrt{\frac{2 ln 2}{π}} \frac{{λ}^{2}}{Δλ}$$

where τ_{c} is the coherence time, c is the speed of light, λ and Δλ are the central wavelength and the full width half maximum (FWHM) of the emission peak, respectively. At θ=30°, the temporal coherence length of the emission peak located at λ=10.52 μm is L_{c}=0.62 mm which is as large as 59λ. The emission peaks exhibit a Q-factor of 85, which is significantly higher than experimental results obtained from Γ point BICs operating within this wavelength range 10 μm-12 μm. Due to impurities in the silicon film and optical losses associated with sputtered silicon, the experimental Q-factors are, however, lower than the predicted numerical values of the quasi-BIC emissions. While the imaginary part of the permittivity determining the optical loss of the system is negligible for single crystalline silicon, the amount of optical loss can be considerable for amorphous silicon (a-Si) depending upon the silicon structure, defects, and doping. Improving the quality of the deposited silicon film the optical loss of the dielectric layer may be decreased, resulting in much higher Q-factor emission peaks.

The emissivity spectrum can also be determined by measuring the thermal radiation emitted from the metasurface.

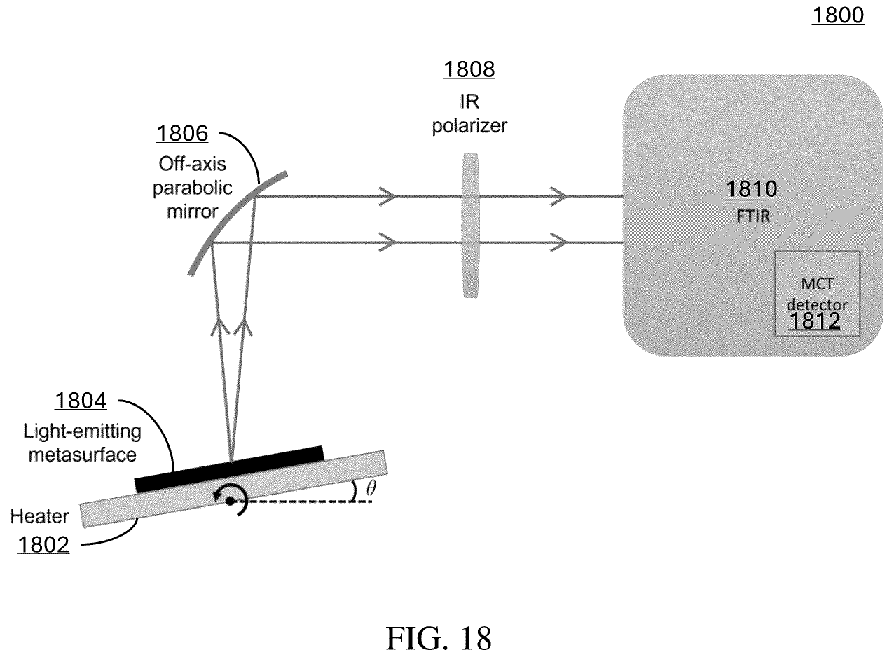

FIG. 18 displays a schematic representation of an experimental setup 1800 for determining emissivity at a fixed observation angle. Setup 1800 comprises a heater 1802 positioned beneath a metasurface 1804. The metasurface 1804 is heated by heater 1802 to generate thermal emission. Light emitted from metasurface 1804 propagates toward and is collected by an off-axis parabolic mirror 1806. The mirror 1806 collimates the emitted light and directs it toward an IR polarizer 1808. The IR polarizer 1808 filters the light to select a specific polarization state, such as TE-polarized light. After passing through IR polarizer 1808, the polarized light enters an FTIR 1810, which is a Fourier transform infrared spectrometer. The FTIR 1810 analyzes the spectral characteristics of the emitted light. The light is then detected by an MCT detector 1812, which is a mercury-cadmium-telluride detector that measures the intensity of the thermal emission as a function of wavelength. This experimental configuration enables the determination of the emissivity spectrum of metasurface 1804 at a fixed observation angle by measuring the thermal radiation directly emitted from the heated metasurface structure. The angle θ indicated in the figure represents the emission angle at which the thermal radiation is collected, allowing for angle-resolved emissivity measurements that may characterize the directional emission properties of the metasurface.

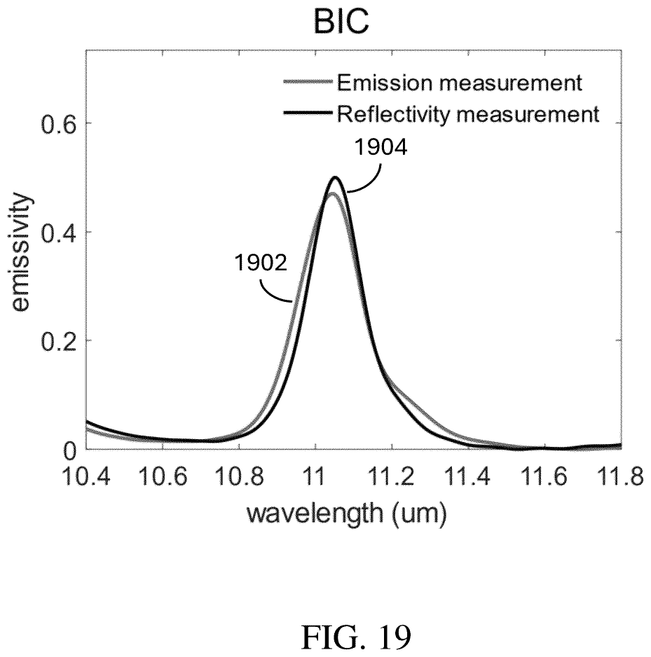

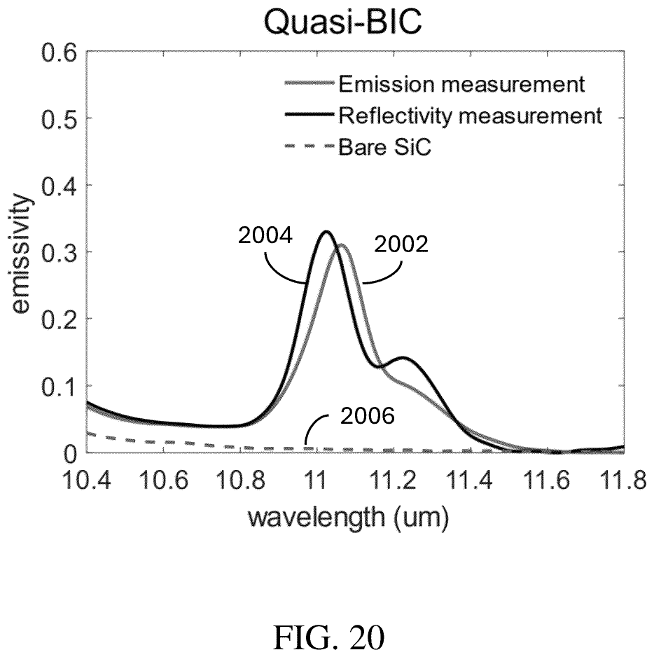

For example, the experimental setup used for thermal emission measurements to collect the emitted light from the fabricated metasurface by an FTIR spectrometer was used for measurements at θ=59° and θ=55° using a 4H—SiC substrate. During the measurement, the sample was heated to 96° C. in order to increase the intensity of the signal to be detected by a mercury-cadmium-telluride (MCT) detector. The emissivity spectrum can be quantified as

$$ε ( λ ) = {ε}_{b} ( λ ) \times [ \frac{{S}_{e} ( λ , {T}_{e} ) - {S}_{r} ( λ , {T}_{r} )}{{S}_{b} ( λ , {T}_{b} ) - {S}_{r} ( λ , {T}_{r} )} ] \times [ \frac{B ( λ , {T}_{b} ) - B ( λ , {T}_{r} )}{B ( λ , {T}_{e} ) - B ( λ , {T}_{r} )} ]$$

where ε_{b} is the known emissivity spectrum of a blackbody reference source. Sₑ, Sₚ, and Sᵣ represent the intensity measured from the light-emitting metasurface, blackbody source, and background room radiation, respectively, at the temperature Tₑ, T_{b}, and Tᵣ. The Plank function at temperature T corresponding to the blackbody radiation distribution is given by B(λ,T) where h and k_{B} are the Planck and Boltzmann constants, respectively. FIG. 19 shows the TE-polarized emission from the metasurface as determined by thermal emission measurements taken at fixed observation angle 59° which corresponds to the formation of the Friedrich-Wintgen BIC. The emissivity spectrum determined from the thermal emission measurement 1902 at emission angle θ=59°, corresponding to BIC radiation spectrum, confirms the emissivity spectrum obtained from reflectivity measurement 1904. FIG. 20 also displays emissivity at angle 55°, demonstrating the quasi-BIC radiation spectrum. The emissivity spectrum determined from the thermal emission measurement 2002 at emission angle θ=55°, corresponding to quasi-BIC radiation spectrum, confirms the emissivity spectrum obtained from reflectivity measurement 2004. Line 2006 illustrates the emissivity of the bare 4H—SiC substrate. In terms of emissivity, there is a very consistent agreement between thermal emission and reflectivity measurements. The emission peak determined by thermal radiation experiments, however, appears broader than the reflectivity measurement result due to the imaginary part of SiC permittivity increasing slightly with temperature. The total emitted power per unit area can be obtained by

$$P = {\int }_{{λ}_{1}}^{{λ}_{2}} ε ( λ ) \cdot B ( λ , T ) d λ .$$

For the single coherent emission peak at θ=59°, illustrated in FIG. 20, the total emitted power per unit area is 2.52 W m⁻². Considering the exemplary chip size, 20 mm by 20 mm, the coherent light-emitting metasurface is capable of emitting 1 mW, indicating that the light emitter has sufficient brightness for medical applications. This amount of power is 11 times greater than the total power emitted by a bare SiC substrate at the wavelengths of interest, and it can be further amplified by increasing the temperature.

At the angle θ=59°, the numerical analysis indicates an unwanted power loss of 25%, attributed primarily to first-order diffraction into the substrate. This phenomenon has a noticeable impact on the total radiated power, potentially affecting the efficiency of the coherent light-emitting metasurface. Despite this, the exemplary coherent light emitter maintained a substantial output, capable of providing 1 mW of power at the desired emission angle of θ=59°. This level of performance underscores the suitability of the emitter for practical applications. The observed unwanted power loss may not be a fixed limitation but rather a parameter dependent on the emission angle. By adjusting to lower emission angles, the unwanted power loss associated with first-order diffraction can be minimized or even eliminated for emission angles less than θ=36°. This adaptability offers a pathway to optimize the configuration of the metasurface for enhanced performance, allowing for a balance between desired emission characteristics and minimal energy loss.

In order to estimate the absorption losses linewidth associated with fabrication imperfection, the measured emission peak at the emission angle θ=59° can be represented by a Fano formula given by F(ω). Here, D is a coefficient corresponding to the peak amplitude, x=(ω−ω₀)/γ₀ is the normalized frequency offset where ω₀ and γ₀ are the resonance frequency and broadening, respectively. According to the Fano formula, the measured emission peak has a linewidth of Δωₑₓₚ=12.2 cm⁻¹. By considering the linewidth of Δωₙ=2 cm⁻¹ calculated from the numerical result, the absorption losses linewidth associated with material optical losses and fabrication imperfections is estimated to be 10.2 cm⁻¹. Various embodiments comprise In the pursuit of advancing metasurface designs within the realms of fabrication and material limitations supercritical coupling for influencing the amplitude and Q-factor of emission peaks in the near-BIC regime. This approach, closely aligned with the Friedrich-Wintgen condition increases emissivity amplitude by leveraging the unique interplay between radiative and nonradiative losses to enhance field intensities beyond conventional limits. Incorporating this method may boost emissivity, offering a solution to the challenges posed by current fabrication and material constraints.

According to one or more exemplary implementations, the first implementation of off-Γ Friedrich-Wintgen BICs in the mid-IR range is demonstrated. Through the formation of BICs, various embodiments comprise a temporally coherent phononic-based light-emitting metasurface at mid-IR wavelengths. In spite of the realistic intrinsic loss of the phononic substrate, the demonstrated thermal source produces high Q-factor emission peaks. As a result of the interaction of two resonances, Friedrich-Wintgen BICs are observed, which lead to the avoidance of resonance crossings. The effect of the dielectric layer on both resonances was investigated. The near BIC field distribution also exhibits significant enhancement and localization within the dielectric layer. A reflectivity measurement was conducted after the metasurface was fabricated to assess the emissivity spectrum of the emitter.

The experimental results of reflectivity revealed quasi-BIC emissions and interference arising from Friedrich-Wintgen resonances. In order to measure the emitted light directly from the metasurface, a thermal emission experiment was performed that confirmed the reflectivity results. According to both experimental results, the emission peak was temporally coherent. In this report of the mid-IR emitter based on off-T Friedrich-Wintgen BICs, the peak amplitude and Q-factor were less than the numerical values due to optical losses associated with the sputtered dielectric film.

A higher Q-factor may be achieved by improving the quality of the deposited dielectric layer. Light emitters such as demonstrated in exemplary implementations may be used for advancing mid-IR spectroscopy, optical communications, and photonic integrated circuits, thereby paving the way for the development of next generation optical devices in the mid-IR range. Their cost-effectiveness, simple fabrication process, and high spectral purity may enable the realization of miniaturized spectrometers, enhance data transmission rates in optical communications, and facilitate the integration of coherent light sources into photonic chips.

According to one or more exemplary implementations, numerical analyses of emissivity and nearfield distributions may be conducted using the RCWA method, tailored to the specific requirements of metasurface modeling. This approach may enable the precise calculation of reflectivity across various diffracted orders, from which emissivity may be derived as ε=1−R where R is the sum of reflection coefficients of all propagating diffraction orders of the system. The analysis account for incident light characteristics corresponding to exemplary conditions, enabling a rigorous and comprehensive modeling of the optical response of the metasurface. The iterative inclusion of a sufficient number of Fourier harmonics guarantees the convergence of the calculations, ensuring the reliability of the numerical results presented herein.

According to one or more exemplary implementations, the reflectivity spectrum in response to a TE-polarized incident light was collected using a Bruker FTIR spectrometer model Invenio-R. The emissivity spectrum was determined according to Kirchhoff's law as ε(λ,θ) where A(λ,θ) and R(λ,θ) represent absorptivity and reflectivity spectra, respectively.

According to one or more exemplary implementations, in order to determine the emissivity spectrum using the thermal radiation experiment, the light-emitting metasurface may be mounted on an on-axis rotary stage to measure the emitted light at the desired observation angle. For example, the metasurface may be heated to 96° C. (the sample temperature may be monitored by a thermometer) using a substrate heater to increase the intensity of the measured signal. An off-axis parabolic mirror may be used to collimate the light emitted from the sample located at its focal point. The emitted light may be collected by the mercury-cadmium-telluride (MCT) detector of the FTIR spectrometer after propagating through an IR polarizer and becoming TE-polarized. To obtain the emissivity, the background radiation may be collected through the input window of the FTIR spectrometer. For example, the signal from a blackbody reference source with emissivity ε=0.8 operating at the temperature of 450° C. was also collected.

Surface phonon polaritons (SPhPs) can be excited by polar crystals such as silicon carbide (SiC) to design partially coherent thermal sources. However, due to intrinsic losses in these materials, the quality factor (Q-factor) of emission peaks may be limited to 100. As compared to ultra-narrowband light emitters operating in the visible and NIR ranges, SiC light sources have a much lower Q-factor, so they may not be suitable for midIR applications such as infrared sensing, imaging, and lasing.

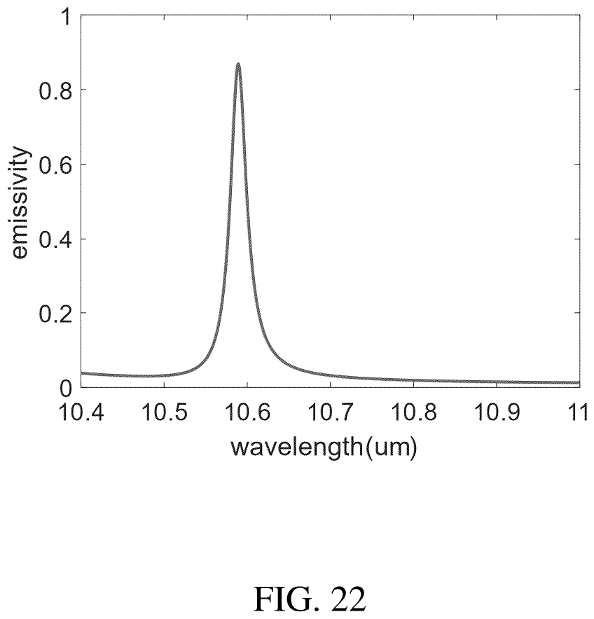

In order to realize ultra-narrowband coherent light emitters in the mid-IR range, according to one or more exemplary implementations, metasurfaces empowered by bound states in the continuum may be utilized. These light-emitting metasurfaces may provide emission peaks with Q-factors in the range of 700 which may be much higher than the Q-factor of current light sources operating at wavelengths longer than 7 μm in the mid-IR range. FIG. 22 illustrates the emissivity of such a light source as a function of wavelength for an emission angle of θ=25°, where the metasurface parameters are p=6.6 μm, d=2 μm, h₁=440 nm, and h₂=1150 nm.

Bound states in the continuum are trapped modes of the system that lie inside the radiation spectrum without leakage. Recently, they have gained popularity in photonics and optics as they can provide strong light enhancement which may be beneficial for many applications, including lasing, sensing, and nonlinear optics. While true BICs cannot radiate as they are protected by structural symmetry or destructive interferences, by introducing perturbations to the structure or parameter tuning, true BICs may become quasi-BICs and turn into high-Q resonant states.

Bound states in the continuum are generally categorized based on their locations in the Brillouin zone: at the Γpoint or off-Γpoints, with each category exhibiting distinct physical properties and formation mechanisms. Γpoint BICs occur at the center of the Brillouin zone and are usually associated with, but not limited to, symmetry-protected mechanisms. Off-Γ BICs, on the other hand, occur away from the center and can arise due to accidental phase matching conditions or through the engineering of specific properties of the photonic structure, such as periodicity or dielectric contrast. All types of BIC that can be formed in periodic structures, such as metasurfaces, are listed below.

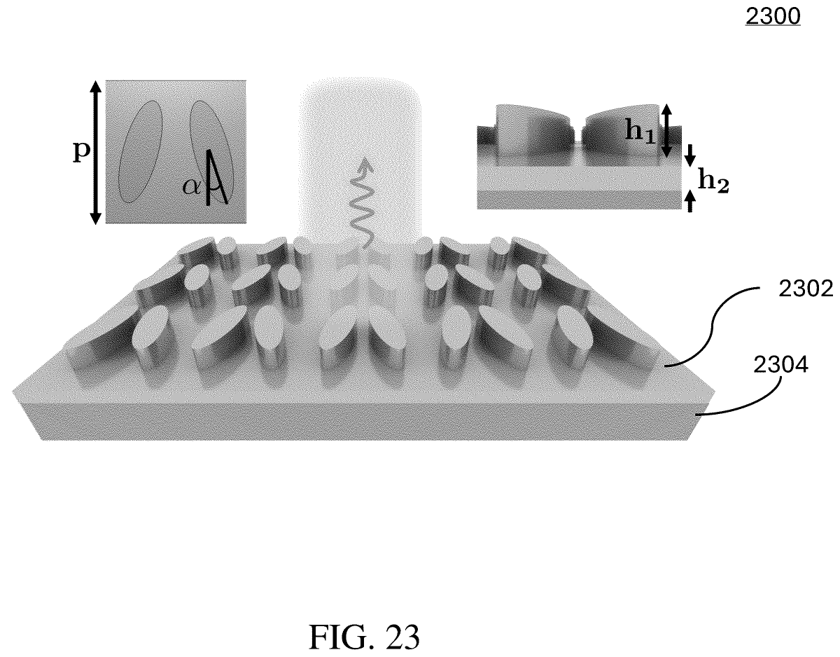

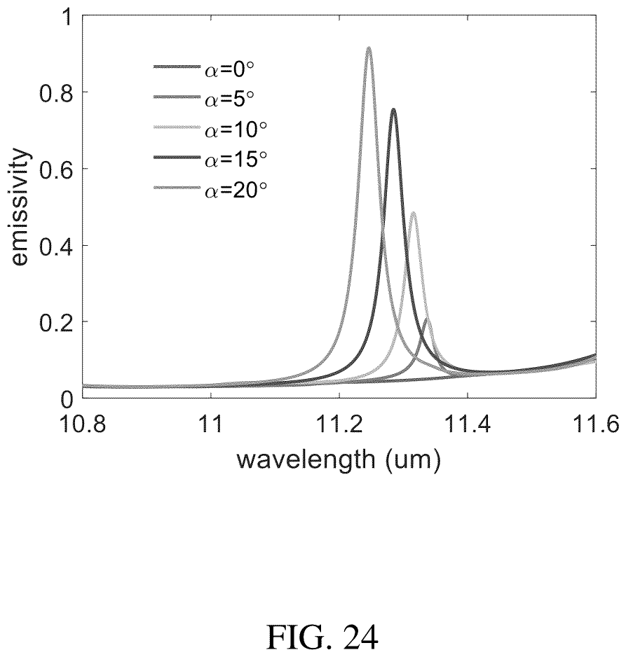

Symmetry-Protected BICs: Symmetry-protected BICs (SP-BICs) are localized and trapped at the center of the Brillouin zone (Γ-point) due to the symmetry of the structure. Upon breaking the lattice symmetry, they start to radiate and become quasi-BICs with a finite resonance linewidth. The near-BIC regime exhibits high Q-factor resonances that can be employed to realize chip-scale coherent light emitters. An exemplary implementation of a coherent light-emitting metasurface capable of forming SP-BICs is illustrated in FIG. 23. FIG. 23 illustrates a schematic of a light emitting metasurface 2300 in accordance with one or more embodiments of the present disclosure. Metasurface 2300 comprises a phononic substrate 2304 and a dielectric layer 2302. For example, metasurface 2300 comprises tilted Si-bar pairs with a unit cell design having parameters p=6.5 μm, h₁=1 μm, h₂=0.5 μm, and bar semi-axes of 0.8 μm and 2.4 μm. When the symmetry of the unit cell is preserved (α=0), the structure supports an SP-BIC which is localized with no radiation. However, when the symmetry is broken (α≠0), the SP-BIC turns into a quasi-BIC, resulting in an emission peak with a finite linewidth. The emissivity of the device as a function of wavelength for TM polarizations for various angles α is shown in FIG. 24.

This platform may provide narrowband emission peaks in the mid-IR range. The asymmetric parameter αmay control the amplitude and Q-factor of emission peaks radiated in the normal direction (perpendicular to the metasurface plane). Besides facilitating optical communication at high data rates in the mid-IR and terahertz ranges, this implementation may offer potential benefits for spectroscopy and sensing as well. The total emitted power per unit area for the coherent light-emitting metasurface may be about 2.6 W m⁻². With a chip size of 20 mm by 20 mm, this platform may emit 1 mW, indicating that the light emitter may be sufficiently bright for medical applications. This amount of power may be 11 times greater than the total power generated by a bare SiC substrate at the wavelengths of interest.

Friedrich-Wintgen BICs: Friedrich-Wintgen BICs (FW-BICs) are formed through resonance interference. When two resonances pass each other as a function of a continuous parameter, interference between them causes an avoided crossing and the formation of a BIC. As a result of this interference, the width of one of the resonances vanishes entirely and hence becomes a BIC. Friedrich-Wintgen BICs which form at an oblique incidence angle, other than the Γpoint of the dispersion diagram of the photonic structures, are referred to as “off-Γ” FW-BICs which has been demonstrated in a recent publication.

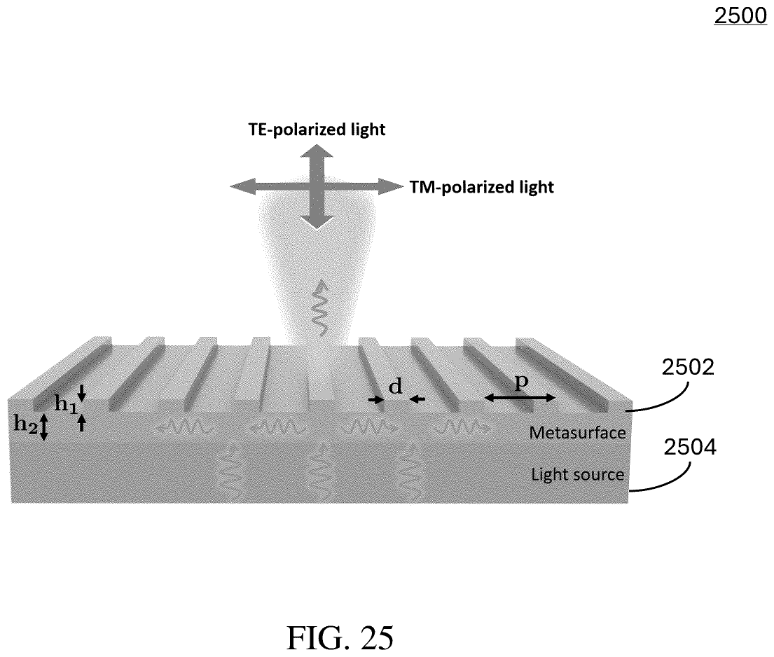

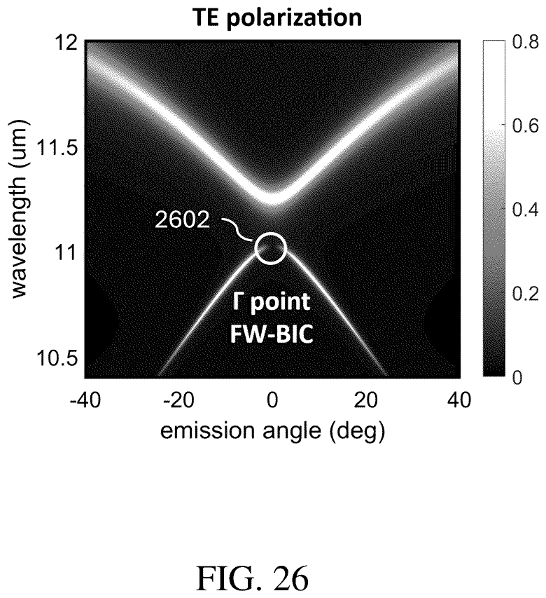

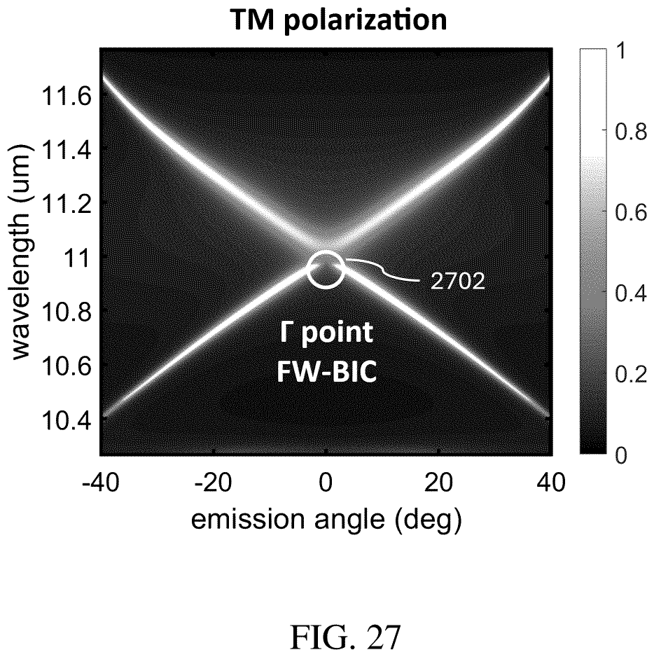

Aside from the off-Γ BICs, the FW-BICs can also occur at the Γpoint of the Brillouin zone. As a result, high Q-factor emission peaks at angles close to normal can be achieved. According to one or more exemplary implementations, the platform may support Γpoint FW BICs for both TE- and TM-polarized light. FIG. 25 illustrates a coherent light-emitting metasurface 2500 in accordance with one or more embodiments of the present disclosure. Metasurface 2500 comprises a phononic substrate 2504 and a dielectric layer 2502. For example, metasurface 2500 is capable of forming Γ point FW-BICs with parameters p=6.6 μm, d=2 μm. The emissivity as a function of emission angle and wavelength is depicted in FIG. 26 for TE polarization, where for TE polarization, h₁=0.2 μm and h₂=1.9 μm, with circle 2602 marking the points at which the Γpoint FW-BICs occur. Similarly, FIG. 27 shows the emissivity of the device as a function of emission angle and wavelength for TM polarization, where for TM polarization, h₁=0.2 μm and h₂=1.9μ, with circle 2702 marking the points at which the Γpoint FW-BICs occur. As the emission angle approaches to zero degree, the resonances approach one another until at one point, the linewidth of one of the resonances drops to zero due to interference of the resonances, resulting in an avoided crossing for the two resonances and a band flip. While the resonance linewidth becomes zero at the BIC point, emission peaks with high Q-factors can be achieved in the quasi-BIC regime. By allowing close-to-normal emission angles, this platform may enable the realization of next-generation coherent light sources in the mid-IR range, such as vertical cavity surface emitting lasers (VCSELs).

Fabry-Perot BICs: These BICs resemble classical Fabry-Perot resonators and are formed in slab waveguide structures. Fabry-Perot BICs are formed in structures that act like optical cavities, where multiple reflections enhance the confinement of light. It may be possible to form these types of BICs when the resonance frequency or the distance, d, between the two structures is tuned such that the round-trip phase shifts add up to an integer multiple of 2π. They are typically found in systems with two identical resonances that are coupled to a single radiation channel. These BICs can be engineered to occur at specific points in the Brillouin zone depending on the geometry and refractive index contrast of the structure. They may be particularly useful in applications requiring confined light and high-Q resonances, such as waveguide based devices, optical filters, and cavity resonators.

Accidental BICs: Accidental BICs are a unique type of BIC that do not rely on specific mechanisms such as symmetry protection, avoiding crossing, or band flipping. Instead, they form accidentally due to fine-tuning of system parameters, leading to a complete decoupling from radiation modes, even in the presence of a single resonance. Accidental BICs occur when the radiation losses of a particular mode are accidentally nullified due to certain parameter settings in the photonic system. This phenomenon can take place even if the system has no particular symmetry or when only a single resonance is present. They are often identified in periodic photonic structures where the dispersion relation allows for such modes to exist at arbitrary points, typically occurring at off-Γ points, in the Brillouin zone. One distinctive feature of accidental BICs is that they require careful tuning of system parameters, such as geometric dimensions or material properties, to achieve the conditions where radiation losses are completely eliminated. Unlike symmetry-protected BICs that rely on inherent symmetry, accidental BICs can appear or disappear as these parameters are adjusted, making them less robust and more sensitive to perturbations.

A significant way to confirm the presence of accidental BICs may be through topological charge analysis. Accidental BICs can be understood and verified by examining the topological charges of the system. In optical systems, BICs can be viewed as vortex centers in the polarization vector field of far-field radiation. The topological charge of a BIC is defined by the winding number of the polarization vector as one moves around a closed loop in momentum space (the kₓ, k_{y} plane) around the BIC. The tunable nature and arbitrary occurrence of accidental BICs may provide unique opportunities for a variety of optical applications, such as resonators, tunable filters, and harmonic generation.

According to one or more exemplary implementations, the high Q-factor resonances present in the quasi-BIC regime may be utilized to harness broadband emissions from thermal sources to realize narrowband emissions in the mid-infrared. To achieve this goal, metasurfaces capable of BIC formation may be designed. As material impurities and optical losses can reduce the Q-factor of resonances, resulting in broadband emissions, optically transparent materials may be selected. In order to realize metasurfaces with minimal optical losses, pure crystalline materials can be bonded to substrates instead of using deposited or sputtered materials. FIG. 28 provides a schematic representation of the fabrication process for coherent light-emitting metasurfaces, depicting a conceptual representation of the metasurface elements where the final geometry may be designed to ensure the formation of BICs.

The emitted radiated power may be directly related to the temperature of the substrate of the light-emitting device and may be heated to enhance the intensity of the emission. To minimize the power required for heating the substrate, the thermal mass of the light source may be reduced. This may be achieved by thinning the substrate to a layer of approximately 10 μm thickness through grinding and polishing. For example, a micro heater capable of delivering power in the milliwatt (mW) range may be sufficient to heat the substrate and generate the necessary emitted power for various applications.

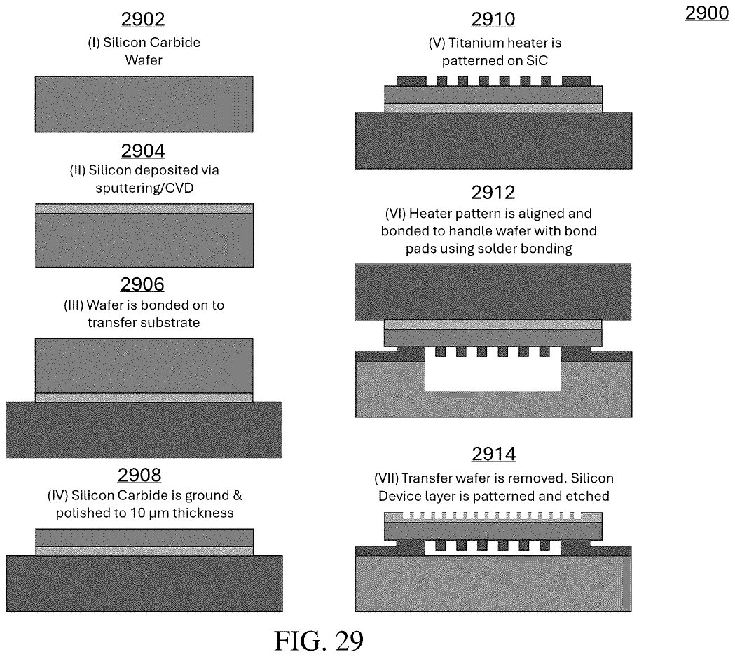

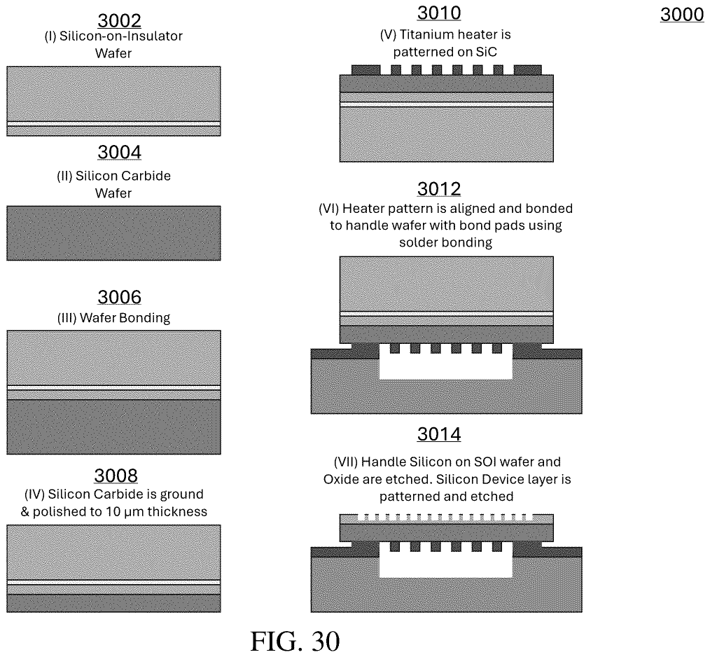

FIG. 29 demonstrates the fabrication process for integrating a membrane heater onto the backside of the light-emitting device with a top silicon layer deposited via sputtering or chemical vapor deposition (CVD), including wafer bonding and subsequent grinding and polishing to achieve a substrate thickness of approximately 10 μm. FIG. 30 presents the fabrication process for integrating a membrane heater using a silicon-on-insulator (SOI) wafer bonded to a silicon carbide (SiC) substrate, illustrating how the heater may be patterned and bonded, followed by etching to form the desired structure. These figures highlight specific fabrication methods, but alternative materials with appropriate properties can be used to achieve similar results, as further detailed in the claims section.

FIG. 29 illustrates a fabrication process 2900 for integrating a membrane heater onto the backside of a light-emitting device. Operation 2902 comprises providing a silicon carbide wafer as the starting substrate material. Operation 2904 comprises depositing silicon via sputtering or chemical vapor deposition (CVD) onto the silicon carbide wafer to form a dielectric layer on the top surface. Operation 2906 comprises bonding the wafer onto a transfer substrate to provide mechanical support during subsequent processing operations. Operation 2908 comprises grinding and polishing the silicon carbide from the backside to achieve a thickness of approximately 10 micrometers, which may reduce the thermal mass of the substrate for efficient heating.

Operation 2910 comprises patterning a titanium heater on the thinned silicon carbide surface using photolithography and metal deposition techniques to create the heating element. Operation 2912 comprises aligning the heater pattern and bonding it to a handle wafer with bond pads using solder bonding, which may establish electrical connections for heater operation. Operation 2914 comprises removing the transfer wafer and patterning and etching the silicon device layer to define the metasurface structures. The fabrication process 2900 demonstrates an exemplary approach for creating a light-emitting device with integrated heating capability, where wafer bonding and subsequent grinding and polishing may achieve the desired substrate thickness for efficient thermal management while maintaining structural integrity throughout the fabrication sequence.

FIG. 30 illustrates a fabrication process 3000 for integrating a membrane heater using a silicon-on-insulator (SOI) wafer bonded to a silicon carbide (SiC) substrate. Operation 3002 may comprise providing a silicon-on-insulator wafer as the starting material, which includes a device silicon layer, a buried oxide layer, and a handle silicon substrate. Operation 3004 may comprise providing a silicon carbide wafer that will serve as the phononic substrate for thermal emission. Operation 3006 may comprise performing wafer bonding to join the silicon-on-insulator wafer to the silicon carbide wafer, creating a composite structure where the SOI wafer is bonded to the SiC substrate through appropriate bonding techniques such as direct fusion bonding or adhesive bonding.

Operation 3008 may comprise grinding and polishing the silicon carbide substrate to achieve a thickness of approximately 10 micrometers, which may reduce the thermal mass of the substrate for efficient heating and improved thermal response characteristics. Operation 3010 may comprise patterning a titanium heater on the thinned silicon carbide surface using photolithography and metal deposition techniques, where the heater may be designed in a meandering pattern to provide uniform temperature distribution across the substrate.

Operation 3012 may comprise aligning the heater pattern and bonding it to a handle wafer with bond pads using solder bonding or other suitable electrical connection methods, which may establish reliable electrical connections for heater operation and power delivery. Operation 3014 may comprise removing the handle silicon layer and buried oxide layers from the SOI wafer through selective etching processes, followed by patterning and etching the exposed silicon device layer to define the metasurface structures with the desired periodic grating patterns. The fabrication process 3000 demonstrates an exemplary approach for creating a light-emitting device with integrated heating capability, where the use of a silicon-on-insulator wafer may provide high-quality crystalline silicon for the metasurface layer while enabling precise control over the dielectric layer thickness and optical properties of the final device structure.

Various embodiments comprise mid-infrared (mid-IR) light-emitting devices and systems. Various embodiments comprise a tunable, chip-scale, ultra-narrowband mid-IR emitter based on metasurfaces that may exploit bound states in the continuum (BICs). Various embodiments may enable real-time spectral tuning using a MEMS-actuated mechanism to adjust the air gap between the metasurface and its underlying substrate.

Conventional mid-IR light sources, such as blackbody radiators and quantum cascade lasers (QCLs), may have certain limitations. Thermal emitters are typically broadband and incoherent, while QCLs may be expensive, power-hungry, bulky, and difficult to integrate into compact platforms. There may be a growing need in industries like spectroscopy, biomedical imaging, gas sensing, and optical communications for compact, coherent mid-IR emitters that offer precise spectral control without the size, cost, and integration challenges that may be associated with existing technologies.

Various embodiments comprise a dynamically tunable, chip-scale coherent mid-IR emitter platform that integrates a suspended monocrystalline silicon metasurface with a heated silicon carbide (SiC) substrate. Spectral tuning may comprise modulating the sub-micron air gap between the metasurface and substrate using MEMS-actuated mechanisms. This enables real-time control over the emission peak location in the quasi-BIC regime.

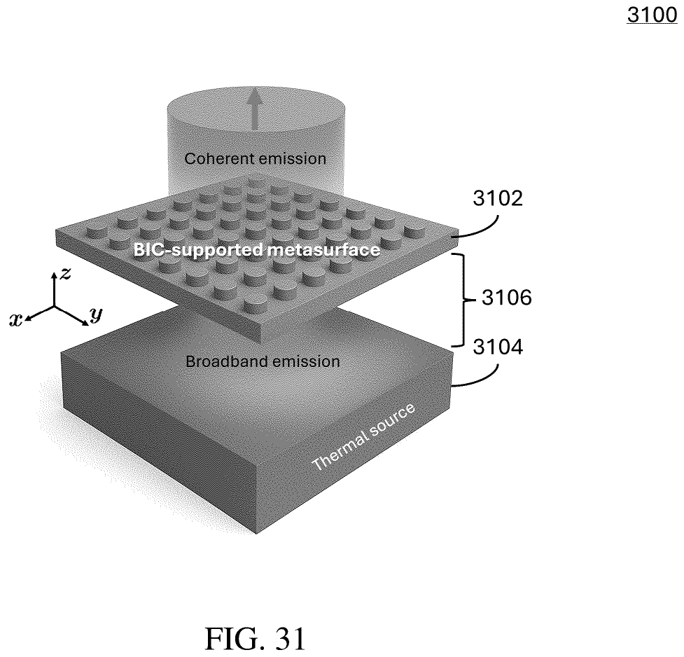

Various embodiments support Q-factors up to ˜1800 and wavelength shifts of over 750 nm. Various embodiments deliver a compact, thermally efficient, and highly tunable solution that significantly outperforms conventional mid-IR sources in flexibility and integration potential. Various embodiments comprise a phononic substrate, a dielectric layer, and an air gap. As shown in FIG. 31, a cavity-enhanced coherent mid-IR emitter architecture comprises a BIC-supported metasurface suspended above a heated thermal substrate that modulates the thermal emission from the substrate producing ultra-narrowband, directional output.

FIG. 31 illustrates a schematic cross-sectional view of a cavity-enhanced coherent mid-infrared emitter 3100. The emitter 3100 comprises a thermal source 3106 positioned at the bottom of the structure, which serves as a heated substrate that generates broadband emission 3104 when thermally excited. Above the thermal source 3106, a BIC-supported metasurface 3102 is suspended, creating a cavity-enhanced configuration.

When the thermal source 3106 is heated, it produces broadband emission 3104 that propagates upward toward the BIC-supported metasurface 3102. The BIC-supported metasurface 3102 may be configured with periodic structures that support bound states in the continuum, enabling the metasurface to filter and modulate the incident broadband emission 3104. Through the interaction between the broadband thermal radiation and the quasi-BIC resonances of the metasurface, the structure produces coherent emission 3100 that exits from the top of the device.

The coherent emission 3100 exhibits ultra-narrowband and directional characteristics as a result of the resonant properties of the BIC-supported metasurface 3102. The suspended configuration of the metasurface above the thermal source creates a resonant cavity that may enhance the interaction between the thermal radiation and the metasurface resonances. This cavity-enhanced emitter 3100 enables the conversion of broadband thermal radiation into spectrally narrow, coherent mid-infrared output, demonstrating how the combination of a thermal emitter and a BIC-supported metasurface may produce highly coherent light emission suitable for various mid-infrared applications.

The dielectric layer may be patterned to support BICs. The dielectric layer may be suspended about the phononic substrate. The phononic substrate may serve as a broadband thermal emitter when heated. The air gap may form a sub-micron resonant cavity between the phononic substrate and the dielectric layer. The size of the air gap may determine the emission wavelength of the emitter. Various embodiments enable dynamic adjustment of the air gap using MEMS actuation. This tuning directly shifts the resonance condition, enabling control over the emitted wavelength. The SiC substrate is thinned (˜10-20 μm) and integrated with a microheater to achieve efficient thermal excitation. The metasurface is patterned to support quasi-BIC modes, enabling high Q-factor narrowband emission peaks in the mid-IR range.

Spectral Tunability: According to various embodiments, a spring-suspended silicon layer, fabricated from an SOI wafer, may enable vertical movement. Electrostatic actuation (with optional piezoelectric alternatives) may modulate the air gap, tuning the resonant condition of the coupled system.

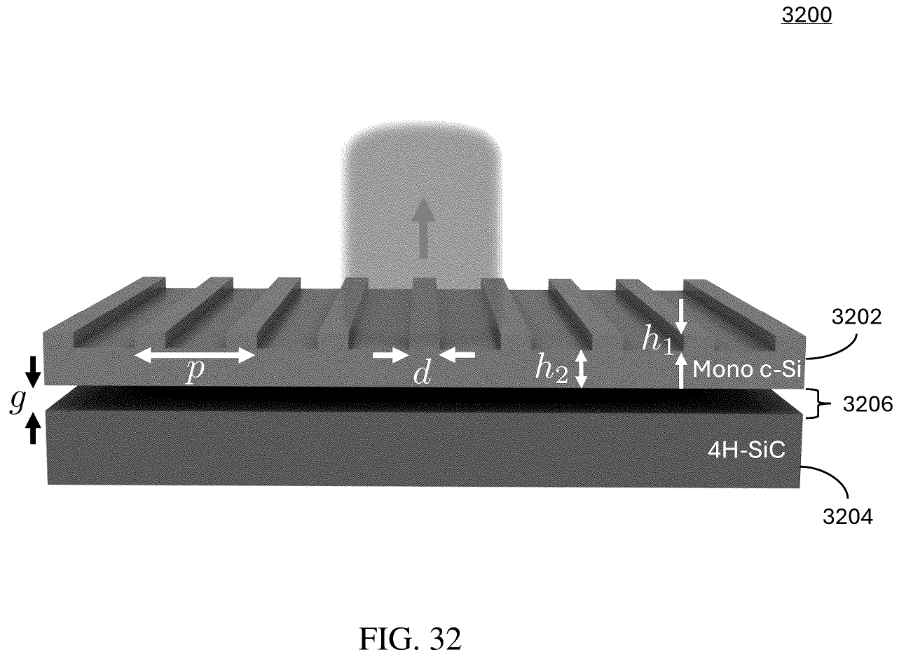

FIG. 32 illustrates a cross-sectional view of a variable gap BIC mid-IR emitter structure. The structure comprises a dielectric layer 3202 positioned above a phononic substrate 3204, with an air gap 3206 separating the two layers. A light emitter 3200 is depicted above the dielectric layer 3202, indicating the direction of light emission from the device. The dielectric layer 3202 features periodic grating patterns formed on its surface, creating a metasurface structure designed to support bound states in the continuum. The phononic substrate 3204 serves as the phononic substrate and thermal emitter. The air gap 3206 between the dielectric layer 3202 and the phononic substrate 3204 forms a sub-micron resonant cavity that determines the emission wavelength of the device. The dimensions of the structure include a period p of 6.6 μm, a width d of 2 μm, a groove depth h₁ of 0.5 μm, and a base layer thickness h₂ of 0.6 μm. The configuration enables the device to produce ultra-narrowband coherent emission in the mid-infrared wavelength range through quasi-BIC resonances, with the air gap 3206 providing tunability for spectral control.

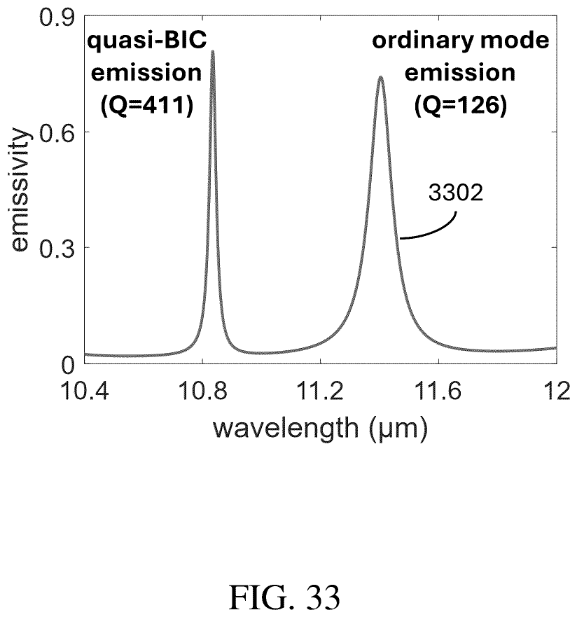

An exemplary emitter has a silicon metasurface suspended above a Silicon Carbide substrate. The exemplary metasurface may have dimensions where p=6.6 μm, d=2 μm, h₁=0.5 μm, and h₂=0.6 μm. The 1D monocrystalline silicon metasurface geometry may be optimized to support BICs. The simulation results were calculated using the RCWA method for TE-polarized light (electric field is along the length of the nanobars) for an emission angle of 10°. FIG. 33 illustrates the emissivity spectrum of the structure with no air gap may show an ultra-narrowband peak (Q≈411) at the wavelength of 10.83 μm, induced by the quasi-BIC resonance. Emissivity curve 3302 demonstrates the emissivity of the device when there is no air gap between the SiC substrate and the Si metasurface, illustrating an ultra-narrowband emission of the quasi-BIC mode at wavelength of 10.83 μm, which has a much higher Q-factor (Q≈411) compared to the ordinary emission mode (Q≈126). By increasing the air gap, the emission peak is shifted to longer wavelengths, and the Q-factor of emission is dramatically improved.

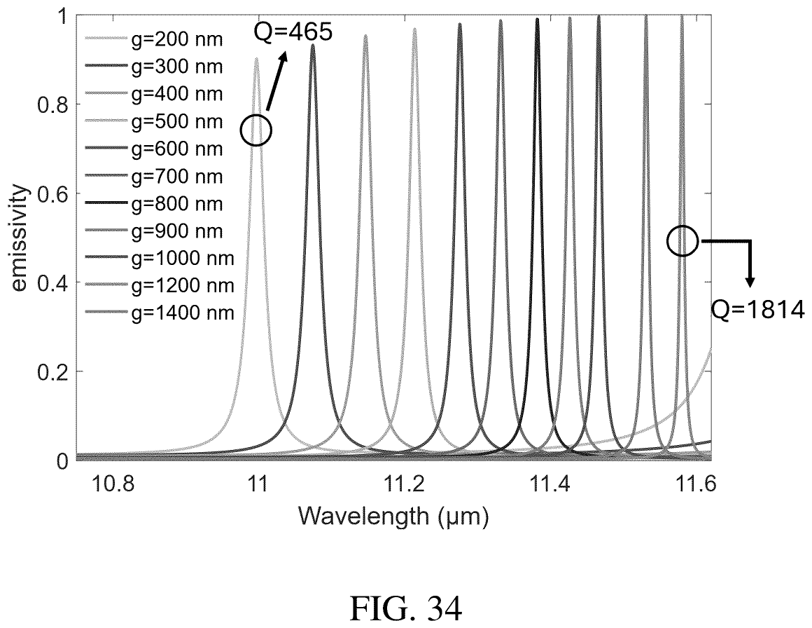

FIG. 34 illustrates the simulated emissivity spectra as the air gap is increased from 0.2 μm to 1.4 μm may show a tunable shift in the emission peak with an increase in Q-factor from 465 to 1814. The simulation results show that by varying the air gap size from 0.2 μm to 1.4 μm, the emission peak moves from 10.99 μm (Q≈464, FWHM≈23.7 nm) to 11.58 μm (Q≈1814, FWHM≈6.4 nm), confirming the unique performance of the tunable cavity-enhanced emitter. Each curve in the figure represents a different air gap thickness, with the curves progressing systematically from shorter to longer wavelengths as the gap dimension increases. The emission peaks become progressively narrower and more pronounced with larger air gap sizes, demonstrating both spectral tunability and quality factor enhancement. The wavelength shift spans approximately 590 nm across the range of air gap variations tested, while the quality factor improvement represents nearly a four-fold increase from the smallest to largest gap configuration.

The simulation results show that by varying the air gap size from 0.2 μm to 1.4 μm, the emission peak moves from 10.99 μm (Q≈464, FWHM≈23.7 nm) to 11.58 μm (Q≈1814, FWHM≈6.4 nm), confirming the unique performance of the tunable cavity-enhanced emitter. This tunability may allow various embodiments to dial in specific mid-IR wavelengths, which may be particularly useful for applications like molecular fingerprinting and atmospheric window communications.

MEMS-Based Tunability: To achieve tunability, various embodiments may integrate the metasurface into a MEMS platform that may allow for controlled variation of the cavity gap between the metasurface and the thermal emitter. According to various embodiments, the metasurface layer may be fabricated from the top silicon layer of an SOI wafer and may be spring-suspended via mechanical tethers or cantilevers designed into the layout. These springs may allow the metasurface to float above the SiC layer, anchored only at the edges of the device.

According to various embodiments, tuning may be achieved through electrostatic actuation by applying a bias voltage between the suspended silicon layer and the substrate. This may pull the metasurface closer to the substrate, effectively narrowing the air gap and red-shifting the resonance condition. Various embodiments may be designed such that this movement can be continuously modulated over a defined range without collapsing the gap (i.e., avoiding pull-in instability).

Initial simulations and fabricated prototypes confirm that this mechanical actuation results in clear spectral tuning of the emitted light in an exemplary embodiment. The emission peak shifts significantly (over 500 nm) with just a 1 μm change in gap size, and the emission linewidth narrows as the system approaches the quasi-BIC condition. This may enable dynamic control over both the wavelength and coherence of the emitted light, paving the way for reconfigurable mid-IR sources.

Emission Characteristics and Performance: According to various implementations, when powered by the microheater, the SiC substrate may emit broadband thermal radiation. This emission may be filtered through the quasi-BIC resonances of the metasurface, potentially resulting in a directional, spectrally narrow, and highly coherent mid-IR beam. Unlike traditional emitters, the spectral peak and linewidth of this beam may not be fixed; they may be modulated in real-time by adjusting the MEMS gap.

Various embodiments may have excellent energy efficiency. Various embodiments may achieve continuous operation at typical target temperatures (100-200° C.) using less than 400 mW of electrical power. Emissivity maps for various embodiments may show that the emission linewidth remains under 10 nm, with brightness levels that may be sufficient for applications in chemical sensing, spectroscopy, and free space optical communications.

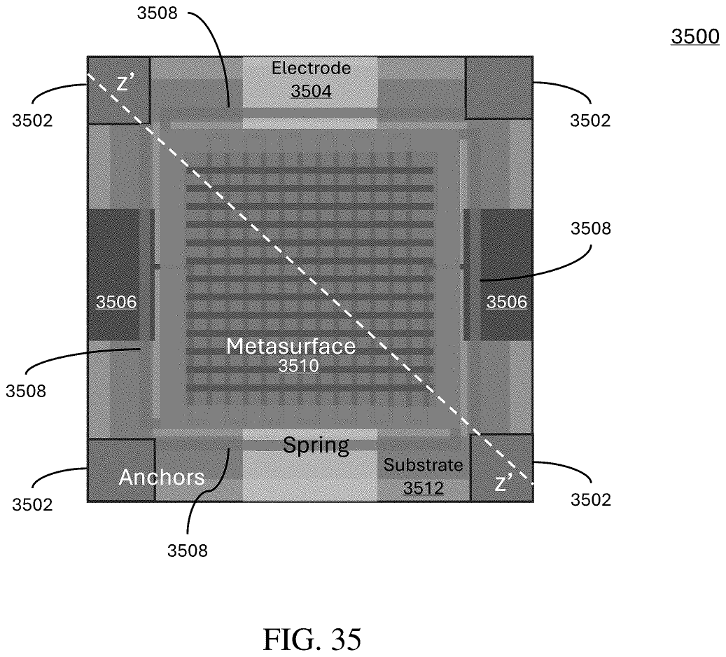

Fabrication Process: According to various implementations, the fabrication process involves three wafers: an suspended metasurface layer, a thermally emissive substrate, and a mechanical support frame. For example, the fabrication process involves three wafers: an SOI wafer (for the suspended metasurface layer), a 4H—SiC wafer (as the thermally emissive substrate), and a borosilicate glass wafer (as a mechanical support frame). FIG. 35 is a schematic illustration of a top view of a tunable quasi-BIC IR emitter 3500 may be provided.

FIG. 35 illustrates a top view of a tunable quasi-BIC IR emitter 3500 in accordance with one or more embodiments of the present disclosure. The tunable quasi-BIC IR emitter 3500 comprises a phononic substrate 3512 that provides a base structure for the device. A dielectric layer 3510 is positioned centrally within the device and features a periodic grating pattern consisting of parallel elongated bars arranged in a regular array. The dielectric layer 3510 may be designed to support bound states in the continuum for coherent mid-infrared light emission.

The dielectric layer 3510 may be mechanically supported by springs 3508 that extend outward from the dielectric layer 3510 toward the periphery of the device. The springs 3508 may be configured to allow vertical displacement of the dielectric layer 3510 relative to the phononic substrate 3512, enabling tunable adjustment of an air gap between these layers. Four springs 3508 may be positioned at the corners of the dielectric layer 3510, connecting the dielectric layer 3510 to anchors 3502 located at the outer edges of the structure. The anchors 3502 may provide fixed attachment points that secure the springs 3508 to the phononic substrate 3512 while permitting the dielectric layer 3510 to move vertically in response to actuation forces.

An electrode 3504 may be positioned on the phononic substrate 3512 adjacent to the dielectric layer 3510. The electrode 3504 may be configured to enable electrostatic actuation of the dielectric layer 3510 by applying a voltage between the electrode 3504 and the dielectric layer 3510, thereby modulating the air gap and tuning the optical resonance characteristics of the device. An adhesion layer 3506 may be disposed on the phononic substrate 3512 beneath the dielectric layer 3510 region, facilitating bonding between different material layers in the device structure.

The arrangement of components in tunable quasi-BIC IR emitter 3500 may enable MEMS-based tunability, where the spring-suspended dielectric layer 3510 can be actuated to vary the cavity gap between the dielectric layer 3510 and the underlying phononic substrate 3512. This configuration may provide dynamic control over the emission wavelength and spectral characteristics of the mid-infrared light emitter. The dashed line labeled z′-z′ indicates the cross-sectional plane that may be referenced in subsequent figures to show the internal structure and layered architecture of the device.

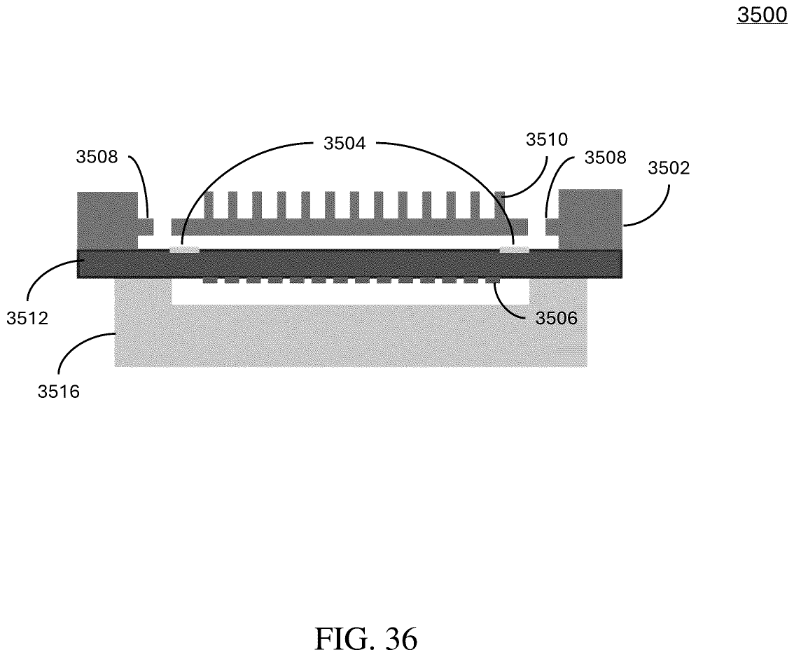

FIG. 36 is a schematic illustration of a cross-sectional view of tunable quasi-BIC IR emitter 3500 along the dashed line z′-z′. The cross-sectional view shows a support frame 3516 positioned at the bottom of the structure, which provides mechanical support for the device assembly. The cross-sectional view demonstrates how the springs 3508 may enable vertical movement of the dielectric layer 3510 in response to electrostatic forces generated by applying a voltage between the electrode 3504 and the dielectric layer 3510. The anchors 3502 provide fixed attachment points that secure the springs 3508 to the underlying structure while permitting the dielectric layer 3510 to move vertically. The adhesion layer 3506 facilitates bonding between the phononic substrate 3512 and overlying layers. This vertical displacement may modulate the size of the air gap between the dielectric layer 3510 and the underlying layers, thereby tuning the optical resonance characteristics and emission wavelength of the device.

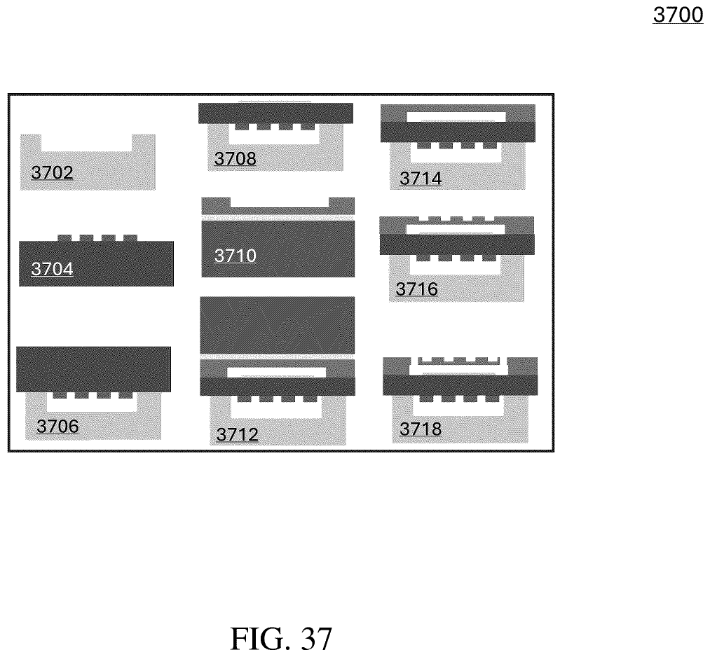

FIG. 37 providing a schematic illustration of the fabrication process 3700 described in the text. Operation 3702 may comprise support frame etching. For example, operation 3702 may comprise anisotropically etching a borosilicate wafer to create a mechanical cavity that accommodates the patterned microheater on the backside of the 4H—SiC wafer. Operation 3704 may comprise heater patterning. For example, operation 3704 may comprise patterning a Ti/Pt microheater on the backside of the 4H—SiC wafer using standard lift-off photolithography and through sputtering or deposition methods such as electron-beam evaporation or chemical vapor deposition (CVD). The heater may be designed in a meandering pattern to provide uniform temperature distribution.

Operation 3706 may comprise substrate bonding. For example, operation 3706 may comprise bonding the etched borosilicate wafer to the SiC wafer using high-temperature compatible epoxy. This may provide mechanical support while preserving access to the topside of the 4H—SiC wafer. Operation 3708 may comprise substrate thinning. For example, operation 3708 may comprise thinning the SiC wafer from the front side down to approximately 10-20 μm using mechanical grinding and chemical-mechanical polishing (CMP), which may improve the thermal response. In some aspects, operation 3708 may comprise patterning the gold actuation electrodes on SiC.

Various embodiments may comprise SOI wafer preparation and bonding. For example, operation 3710 may comprise etching the device layer of the SOI wafer using a precision reactive ion etching (RIE) process to a desired depth. Operation 3712 may comprise aligning and bonding the SOI wafer to the SiC layer using a few tens of nanometer-thick epoxy bonding. Operation 3714 may comprise removing the handle silicon layer and the buried oxide layers via etching. Operation 3716 may comprise patterning and etching the exposed device silicon layer with precision using RIE process to define the metasurface nanostructures. Operation 3718 may comprise releasing the MEMS structures. For example, the device silicon layer may be patterned to realize the silicon spring structures by etching through the thickness of the silicon and leaving the central metasurface and springs suspended above SiC. This may form the tunable MEMS cavity.

The metasurface may comprise any optically transparent material in the mid-IR range including but not limited to silicon (Si), Gallium Arsenide (GaAs), Indium Arsenide (InAs), Germanium (Ge), Calcium Fluoride (CaF₂), Barium Fluoride (BaF₂), Zinc Selenide (ZnSe), Gallium Antimonide (GaSb), or Indium Phosphide (InP). The substrate may comprise any thermal or blackbody source, plasmonic or phononic material. This may include but is not limited to Silicon Carbide, Aluminium Nitride (AlN), Gold (Au), Quartz (SiO₂), Tungsten (W), Carbon-Based Materials, Indium Arsenide, Indium Gallium Arsenide, Indium Antimonide, Ceramic Materials (such as Al₂O₃, ZrO₂, HfO), or Chalcogenide Glasses.

The metasurface layer on top of the substrate may be fabricated by a variety of methods, including but not limited to wafer bonding, deposition, direct-write, or additive micro-nanofabrication techniques. These deposition methods may encompass all physical vapor deposition processes including but not limited to RF or DC sputter deposition, electron-beam (e-beam) evaporation, molecular beam epitaxy (MBE), pulsed laser deposition, and all chemical vapor deposition methods including but not limited to atomic layer deposition (ALD), chemical vapor deposition (CVD), low-pressure chemical vapor deposition (LPCVD), high-pressure chemical vapor deposition (HPCVD), metal-organic chemical vapor deposition (MOCVD), any spin coating methods and any other physical or chemical vapor deposition techniques suitable for film fabrication. This may include but is not limited to standard and modified versions of these techniques, as well as any combination thereof to achieve the desired metasurface characteristics. In some aspects, the fabrication may further include spin-coating, sol-gel, or solution-based deposition processes. It may also encompass additive and subtractive nanofabrication approaches, such as 3D nanoprinting, femtosecond-laser ablation, selective-area epitaxy, etch-back and lift-off processes, and any hybrid combinations thereof that enable the creation of the desired metasurface geometry, topology, or optical properties.

The metasurface layer may also be bonded to the substrate using various bonding techniques, including but not limited to direct (fusion) bonding, anodic bonding, adhesive bonding, intermediate layer bonding, hydrophilic and hydrophobic bonding, thermocompression bonding, metal diffusion bonding, van der Waals bonding, plasma-assisted bonding, glass frit bonding, and laser-assisted bonding. These bonding methods, either individually or in combination, may be utilized to achieve the desired attachment of the wafer to the substrate, providing versatility in terms of material compatibility, bonding strength, and application-specific requirements.

In cases where the wafer, metasurface layer, has been bonded to the substrate, it may be tailored to the desired thickness using various methods, including but not limited to grinding, polishing, or wet or dry etching as shown in FIG. 37.

The materials used for the metasurface may exhibit a variety of morphologies, including but not limited to amorphous, polycrystalline, single-crystalline, or monocrystalline structures. The morphology may be controlled or influenced based on the deposition or fabrication method used, and may include mixed-phase structures, nanocrystalline formations, or textured crystalline arrangements. These morphologies may be selected or engineered to achieve specific optical, electrical, or mechanical properties of the metasurface, providing versatility in performance depending on the application requirements.

The metasurface patterns and features may be created using various methods, including but not limited to photolithography, electron-beam (e-beam) lithography, 3D printing, direct printing, embossing, nanoimprint lithography, interference lithography, and any other suitable patterning techniques. This may also include techniques such as dry etching (e.g., reactive ion etching, plasma etching) and wet etching, as well as lift-off processes or direct printing of such patterns. Additionally, deep-UV and interference lithography, direct-write laser lithography, two-photon absorption/two-photon polymerization lithography, focused ion beam (FIB) milling, and additive manufacturing methods may be utilized for defining the patterns. Any of these methods, or a combination thereof, may be employed for realizing, marking, and creating the desired metasurface features.

The metasurface features or patterns may take on various shapes and distributions, which may be configured in either periodic or non-periodic arrangements, including unit cells, supercells, or combinations thereof with or without strict periodicity. The features may be designed specifically to support bound states in the continuum (BICs), including but not limited to symmetry-protected BICs, Friedrich-Wintgen BICs, Fabry-Perot BICs, and accidental BICs. These shapes may be symmetric or non-symmetric and encompass a broad range of geometries to facilitate different types of BICs. The shapes may include, but are not limited to, gratings, nanobars or microbars, tilted bars, asymmetric pairs of bars, split-ring structures, nanodisks with asymmetric holes, elliptical structures, rectangular and triangular structures, square blocks, circular disks, ring-shaped elements, hexagonal elements, crosses, U-shaped, H-shaped, L-shaped, and C-shaped nanoantennas. Complex forms such as dumbbell-like structures, Fano-resonant asymmetric wire pairs, and square split-ring resonators may also be included, as well as any other arbitrary, fractal-like, or hybrid geometries that may exhibit the desired resonance properties amongst any other. The metasurface features may be distributed in lattices of various symmetries, such as square, rectangular, hexagonal, or triangular arrangements, and may also include quasi-crystalline or aperiodic arrangements. The structures may be designed to achieve and optimize specific resonance properties, enabling control over coherence, radiation suppression, and field enhancement as required for different BIC phenomena.

The metasurface, as described, may be configured to function as a selective transmitter or absorber, forming narrowband transmission or absorption windows based on the principles of bound states in the continuum (BICs). These configurations may allow for precise control over the spectral response, enabling applications in filtering, sensing, and tailored electromagnetic manipulation.

The light-emitting device may comprise a metasurface, sub-micron MEMS-based air gap, substrate, and an integrated membrane heater, wherein the substrate may be thinned to approximately 10 μm to reduce thermal mass, enabling efficient heating with a micro heater operating at milliwatt (mW) power levels. The integration of the membrane heater may be configured through processes that include, but are not limited to, deposition techniques such as sputtering or chemical vapor deposition (CVD), as demonstrated in FIG. 37. The light-emitting device may be designed to emit sufficient radiated power for various applications with minimal power input, providing efficient thermal management through the reduced thermal mass of the substrate.

Various embodiments may include methods of designing, optimizing, and implementing metasurface structures and features that support bound states in the continuum (BICs) and quasi-BICs, including but not limited to employing physics-based, machine learning-assisted, and computational optimization techniques to achieve ultra-narrowband, high-Q emission in the mid-infrared spectrum. This may encompass the use of any inverse design, topology optimization, or computational design framework that identifies optimal metasurface geometries, unit cell configurations, or periodic lattice parameters to enhance and control photonic resonances, including but not limited to:
1. Adjoint-based topology optimization methods for maximizing figures of merit such as quality factor (Q), emissivity, spectral coherence, or polarization selectivity.
2. Inverse design approaches based on coupled-mode theory (CMT), resonance mapping, and Fano-like interference models to target specific emission wavelengths and quasi-BIC modes.
3. Resonance-informed deep learning (RIDL) or any other artificial intelligence or machine learning model trained on electromagnetic simulation data to predict or generate metasurface designs with optimized optical properties.
4. Multi-parameter optimization frameworks that co-optimize emission characteristics such as wavelength, bandwidth, polarization response, angular dispersion, and robustness against fabrication tolerances.
5. Deterministic and stochastic search methods, including but not limited to gradient descent, genetic algorithms, Bayesian optimization, neural network regression, adjoint sensitivity analysis, or Monte Carlo sampling, applied individually or in combination.
6. Hybrid optimization workflows that combine analytical modeling, numerical simulation (including RCWA, FDTD, or FEM), and machine learning-based prediction to achieve targeted quasi-BIC resonances.
7. Design-for-manufacturing (DFM)-constrained optimization processes that may help ensure the fabricated metasurfaces remain compatible with semiconductor and MEMS fabrication tolerances.

In some aspects, this may further include all techniques, methods, and computational approaches, existing or to be developed in the future, that may identify, modify, or optimize the geometry, symmetry, or material distribution of metasurfaces for the purpose of improving the performance, efficiency, tunability, or manufacturability of BIC- and quasi-BIC-based light-emitting devices.

Various embodiments may include a device or system incorporating a tunable air gap between a metasurface and an underlying substrate for the purpose of modulating optical resonances, wherein the gap size may be dynamically varied using mechanical, electro-mechanical, piezoelectric, thermal, or electrostatic actuation mechanisms. This may include all structures, methods, and control techniques capable of enabling vertical displacement or modulation of the separation between the metasurface and the thermally emissive substrate, including but not limited to:
8. MEMS-based actuation systems, such as spring-suspended or tether-supported silicon or other metasurface material membranes, that may enable movement of the metasurface layer relative to the substrate;
9. Electrostatic actuation platforms, including parallel-plate capacitive actuators and voltage-controlled deflection mechanisms;
10. Comb-drive actuators, torsional actuators, and other lateral or vertical MEMS displacement methods that may allow for sub-micron precision in gap modulation;
11. Piezoelectric actuation elements, including integrated piezo stacks or thin-film transducers, that may deform the structure in response to applied voltage;
12. Thermal bimorph or thermo-mechanical actuators, where local heating may induce deflection to alter the gap size;
13. Electromagnetic or Lorentz-force actuators, in cases where magnetic field interaction may enable tunable displacement;
14. Microfluidic or pressure-based platforms, including gas-filled cavities or liquid layers, used to expand or collapse the gap via controlled pressure differentials; and
15. Flexible or deformable substrate architectures, including suspended membranes or tunable polymeric structures that may mechanically respond to external input.

In some aspects, this may encompass any monolithic, bonded, stacked, or hybridized system that incorporates these or similar gap-modulating techniques to enable spectral tuning of metasurface-based light emission. The actuation mechanisms may be realized through silicon, III-V, polymer, glass, or other compatible microfabrication technologies and may be integrated using standard MEMS processing, wafer bonding, or additive manufacturing techniques.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A coherent light-emitting metasurface for mid-infrared wavelengths, comprising:
a phononic substrate;
a dielectric layer bonded to the phononic substrate; and
periodic grating patterns formed in the dielectric layer having dimensions and spacing to create resonant modes coupling radiative and non-radiative states to form off-gamma point Friedrich-Wintgen bound states in the continuum that, when thermally excited, emit coherent light with high quality factor resonances in a wavelength range between 3 micrometers and 50 micrometers.

2. The coherent light-emitting metasurface of claim 1, wherein the phononic substrate comprises silicon carbide.

3. The coherent light-emitting metasurface of claim 1, wherein the dielectric layer comprises silicon.

4. The coherent light-emitting metasurface of claim 3, wherein the silicon has a single-crystalline morphology.

5. The coherent light-emitting metasurface of claim 1, wherein the periodic grating patterns comprise silicon bars having a width of approximately 2 micrometers and a pitch of approximately 6.6 micrometers.

6. The coherent light-emitting metasurface of claim 1, wherein the dielectric layer is bonded to the phononic substrate using direct fusion bonding.

7. The coherent light-emitting metasurface of claim 1, wherein the metasurface produces emission peaks with quality factors of at least 640 in the mid-infrared wavelength range.

8. The coherent light-emitting metasurface of claim 7, wherein the phononic substrate is thinned to approximately 10 micrometers thickness to reduce thermal mass.

9. The coherent light-emitting metasurface of claim 8, wherein the membrane heater operates at milliwatt power levels to heat the thinned phononic substrate.

10. A method of fabricating a coherent light-emitting metasurface for mid-infrared applications, comprising:
creating a composite structure by forming a bonded interface between a dielectric layer and a phononic substrate;
thinning the composite structure to a desired thickness; and
forming periodic grating patterns in the dielectric layer to create a metasurface supporting off-gamma point Friedrich-Wintgen bound states in the continuum for coherent light emission in a wavelength range between 3 micrometers and 50 micrometers.

11. The method of claim 10, wherein said forming the bonded interface comprises one of bonding the dielectric layer to the phononic substrate, sputtering the dielectric layer onto the phononic substrate, and using chemical vapor deposition to deposit the dielectric layer onto the phononic substrate.

12. The method of claim 10, wherein the phononic substrate comprises silicon carbide and the dielectric layer comprises silicon.

13. The method of claim 12, wherein the silicon is single crystalline silicon.

14. The method of claim 12, wherein the forming of periodic grating patterns comprises photolithography followed by reactive ion etching to create silicon bars having a width of approximately 2 micrometers and a pitch of approximately 6.6 micrometers.

15. The method of claim 12, said thinning comprising grinding and polishing the phononic substrate to approximately 10 micrometers thickness, the method further comprising:
patterning a titanium heater on the phononic substrate;
aligning the patterned heater with bond pads on a handle substrate; and
bonding the patterned heater to the bond pads using solder bonding.

16. A mid-infrared thermal emitter, comprising:
a phononic substrate;
a dielectric layer bonded to the phononic substrate, the dielectric layer having a periodic grating structure formed thereon; and
a membrane heater integrated with the phononic substrate, wherein the thermal emitter is configured to produce narrowband coherent emission in the mid-infrared wavelength range between 10 micrometers and 12 micrometers with a quality factor greater than 100.

17. The mid-infrared thermal emitter of claim 16, wherein the phononic substrate has a negative real part of permittivity at wavelengths between 10.3 micrometers and 12 micrometers.

18. The mid-infrared thermal emitter of claim 18, wherein the dielectric layer has a thickness between 1.0 micrometer and 1.5 micrometers and the periodic grating structures have a depth of approximately 0.44 micrometers.

19. The mid-infrared thermal emitter of claim 16, wherein the phononic substrate is thinned to approximately 10 micrometers thickness and the membrane heater operates at milliwatt power levels to efficiently heat the thinned substrate for enhanced mid-infrared emission intensity.

20. The mid-infrared thermal emitter of claim 16, wherein the emission is between 10 micrometers and 12 micrometers and has a quality factor of at least 100.
